(19) United States
(12) Patent Application Publication
(10) Pub. No.: US 2013/0335463 A1
(43) Pub. Date: Dec. 19, 2013

(54) 2D/3D SWITCHABLE DISPLAY DEVICE AND METHOD FOR MANUFACTURING THE SAME

(71) Applicant: Innolux Corporation, Miao-Li County (TW)

(72) Inventors: Pei-Hsuan Chiang, Miao-Li County (TW); Chiao-Fu Yu, Miao-Li County (TW)

(21) Appl. No.: 13/914,671

(22) Filed: Jun. 11, 2013

(30) Foreign Application Priority Data
Jun. 13, 2012 (TW) 101121169
May 3, 2013 (TW) 102115871

(51) Int. Cl. H04N 13/04

(52) U.S. Cl. CPC H04N 13/0409
USPC 345/697; 29/593

(57) ABSTRACT

A 2D/3D switchable display device comprising a display module, an optical control module and a driving module is disclosed. The optical control module comprises a plurality of optical controlling elements. The display module is disposed opposite to the optical control module and thereby relative information is generated. The driving module provides a corresponding pixel data matrix to the display module based on the optical controlling elements and the relative information.

This application claims the benefit of Taiwan application Serial No. 101121169, filed Jun. 13, 2012, and Taiwan application Serial No. 102115871, filed May 3, 2013, the subject matters of which are incorporated herein by reference.

### BACKGROUND OF THE INVENTION

1. Field of the Invention

The invention relates in general to a 2D/3D switchable display device and a manufacturing method thereof, and more particularly to a 2D/3D switchable display device which adjusts pixel information by using an algorithm.

2. Description of the Related Art

Based on the parallax between human's two eyes, three dimensional (3D) display provides respective images to human's two eyes, which then integrate the received images and generate a sense of dimensionality to the viewer. Most of the 3D displays available in the market, despite having matured technology and many disadvantages in terms of signal transmission, synchronicity, pricing, weight, feeling of comfort, and so on, still require the viewer to wear special glasses. Therefore, the naked-eye 3D display technology will become a main-stream technology in the future.

The technology used in the naked-eye 3D mainly includes lenticular lens display and parallax barrier display, both forming stereoscopic images by way of spatial distribution. For the lenticular lens display, the lenticular lens makes the light refracted and emitted at an angle, so that the left image and the right-eye image are correctly projected to the viewer's left eye and right eye respectively. For the parallax barrier display, the barrier areas and the transparent areas are formed according to the light shielding principles and are alternately arranged to form a grating, such that the images viewed by the viewer's left eye and right eye through the slit of the grating are exactly the left-eye and the right-eye images.

FIG. 1A shows a parallax barrier 2D/3D switchable display. Let a 2-view frame be taken for example. The optical control panel 15 is placed in front of the display panel 11 and is located between the human eyes and the display panel 11. When the optical control panel 15 is in a two-dimensional (2D) state, the light, emitted from the backlight module 13 and penetrating the display panel 11, may completely pass through the optical control panel 15 to display a 2D image on the display panel 11 without being affected by the optical control panel 15 at all (the front view). When the optical control panel 15 is in a 3D state, the light, emitted from the backlight module 13 and penetrating the display panel 11, will be affected by the optical control panel 15. Through the design of alternately arranged black and transparent optical controlling elements (barrier grating), the pixels of the display panel 11 visible to the left eye and the right eye are restricted by the optical control panel 15. Under the circumstance of precision alignment and a suitable observation position, the left eye and the right eye respectively see a frame of odd-number pixels and a frame of even-numbered pixels on the display panel 11 and generate a sense of dimensionality.

The naked-eye 3D display using spatial distribution has predetermined viewing positions. If the viewer is not viewing the images from these predetermined viewing positions, the left eye may see a right-eye image and the right eye may see a left-eye image, hence resulting in X-talk and failing to display excellent stereoscopic effect. In a multi-view naked-eye 3D display, when the viewer's left eye and right eye sequentially cross the boundary of a viewing angle period, suppose one of the viewing sequence is reverse (suppose there are 8 viewing angles, and the left eye and the right eye are different by 3 images, then the left eye moves to the 6^{th} image from the 4^{th} image, and the right eye moves to the 1^{st} image from the 7^{th} image), the stereoscopic image will experience reverse parallax and image jumping, causing discomfort to the viewer.

Referring to FIGS. 1B˜1D, schematic diagrams of the moire effect of an image frame and the grating pattern of an optical control panel at different angles are respectively shown. The optical control panel is such as a parallax barrier type optical control panel. The moire effect, being an optical interfering pattern, occurs when two groups of lines with different spatial frequencies overlap each other, hence generating another group of overlapping pattern with different spatial frequencies and affecting 3D image display quality. If the optical control panel and the display panel have similar spatial frequencies and can be precisely assembled together, the moire effect will be reduced and the 3D image viewing quality will be increased.

In the manufacturing process of a naked-eye 3D display, the optical controlling elements need to match with the matrix pixels of the display panel. Furthermore, high precision is required in the alignment and assembly process, and alignment error must be reduced, so that images can be correctly sent to the viewer's left eye and right eye, moire effect is avoided, and stereoscopic images can thus be displayed. Since the alignment and assembly process demanding high precision requires a high level machine (alignment precision ≦5 um) and strict quality control, more time will be required, more difficulties will occur, conformity rate will decrease. As a result, manufacturing cost will be over market value, and product competiveness will deteriorate.

### SUMMARY OF THE INVENTION

The invention is directed to a 2D/3D switchable display device, which adjusts pixel information by using an algorithm, hence increasing stereoscopic effect, reducing viewers' discomfort, and increasing the tolerance of alignment error between the display module and the optical control module.

According to an embodiment of the present invention, a manufacturing method of 2D/3D switchable display device is disclosed. The method comprises the following steps. A display module is provided. An optical control module is provided. The display module and the optical control module are assembled together and are electrically connected to a driving module. A pixel information is provided to the display module by the driving module, comprising: providing N initial view matrix tables formed from a plurality of view pixel information of N view frames, wherein N is the number of view angles and is a positive integer greater or equal to 2; providing N computation tables respectively corresponding to the initial view matrix tables, wherein each computation table has a plurality of weight information each respectively corresponding to each view pixel information; and calculating the sum of the products of the view pixel information and the corresponding weight information to obtain the pixel information.

According to another embodiment of the present invention, a 2D/3D switchable display device comprising a display module, an optical control module and a driving module is disclosed. The display module is assembled to the optical control module. The driving module is electrically connected to the display module and the optical control module to provide a pixel information to the display module. The pixel information is related to N initial view matrix tables and N computation tables, and the initial view matrix tables are formed from a plurality of view pixel information of N view frames, wherein N is the number of view angles, N is a positive integer greater or equal to 2, the computation tables respectively correspond to the initial view matrix tables, each computation table has a plurality of weight information, each weight information respectively corresponds to each view pixel information, and the pixel information is the sum of the products of the view pixel information and the corresponding weight information.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1A shows a generally known 3D display.

FIGS. 1B˜1D respectively show schematic diagrams of the moire effect of an image frame and the grating pattern of an optical control panel at different angles.

FIG. 2A shows a 2D/3D switchable 2D/3D switchable display device according to an embodiment of the invention.

FIG. 2B shows a top view of a display module according to an embodiment of the invention.

FIG. 2C shows a top view of an optical control module according to an embodiment of the invention.

FIG. 2D shows a schematic diagram of an alignment pattern according to an embodiment of the invention.

FIG. 2E shows a schematic diagram of an alignment image with misalignment according to an embodiment of the invention.

FIG. 2F shows a schematic diagram of an alignment image with precision alignment according to an embodiment of the invention.

FIG. 3A shows a schematic diagram of the pixel information of a display module and patterns of an optical control module according to an embodiment of the invention.

FIG. 3B shows computation tables and view matrix tables according to an embodiment of the invention.

FIG. 3C shows an adjusted first view matrix S′1 table.

FIGS. 4˜6 show wave patterns of experimental data of a 5-view computation table according to an embodiment of the invention.

FIG. 7 shows a scenario when a display module and an optical control module are assembled by way of non-precision alignment.

FIG. 8A shows a schematic diagram of the generation of an N-view initial view matrix table Sj(N) according to a second embodiment of the invention wherein N is an even number.

FIG. 8B shows computation tables MX1˜MX8 and view matrix tables Sj1˜Sj8 according to a second embodiment of the invention.

FIG. 9A shows a schematic diagram of the generation of an N-view initial view matrix table Sj(N) according to a second embodiment of the invention wherein N is an odd number.

FIG. 9B shows computation tables MX1˜MX7 and view matrix tables Sk1˜Sk7 according to a second embodiment of the invention.

FIG. 10 shows a schematic diagram of the optical controlling elements at different arrangement angles with different slopes according to an embodiment of the invention.

FIG. 11 shows a schematic diagram of the optical controlling elements arranged with the slope being w/h according to an embodiment of the invention.

FIG. 12 shows a schematic diagram of the optical controlling elements arranged with the slope being w/h for providing corresponding weight information according to an embodiment of the invention.

FIGS. 13A˜13E show schematic diagrams of the arrangements of the view information based on different disposition positions of the optical controlling elements according to an embodiment of the invention.

FIGS. 14A˜14E show schematic diagrams of the products of the view pixel information of the same row of sub-pixels and the corresponding weight information when the optical controlling elements are disposed at different positions).

FIGS. 15A˜15E show schematic diagrams of an array of products of the view pixel information of a plurality of rows of sub-pixels and the corresponding weight information when the optical controlling elements are disposed at different positions.

FIGS. 16A˜16E show schematic diagrams of arranging the separated weight information corresponding to each position in FIGS. 15A˜15E according to corresponding coordinate positions to generate each computation table of the view frame corresponding to each position.

FIGS. 17A˜17E show schematic diagrams of a method of a multiplication of the computation table of the view angle at each position in FIGS. 16A˜16E and corresponding initial view matrix table.

FIG. 18A shows a schematic diagram of the optical controlling elements arranged with the slope being 2w/3h according to another embodiment of the invention.

FIGS. 18B˜18F show schematic diagrams of the weight information recorded in the computation tables of the view angles when the optical controlling elements correspond to different disposition positions as illustrated in FIG. 18A.

FIG. 19A shows a schematic diagram of the optical controlling elements arranged with the slope being 2w/h according to an alternate embodiment of the invention.

FIGS. 19B˜19F show schematic diagrams of the weight information recorded in the computation tables of the view angles when the optical controlling elements correspond to different disposition positions as illustrated in FIG. 19A.

FIG. 20 shows a schematic diagram of an alignment detection method according to an embodiment of the invention.

FIG. 21A shows a frame with misalignment.

FIG. 21B shows a frame with precision alignment.

FIG. 22 shows a flowchart of an alignment detection method according to an embodiment of the invention.

FIG. 23 shows a flowchart of an alignment detection method according to another embodiment of the invention.

FIG. 24 shows a schematic diagram of an alignment detection method according to an embodiment of the invention.

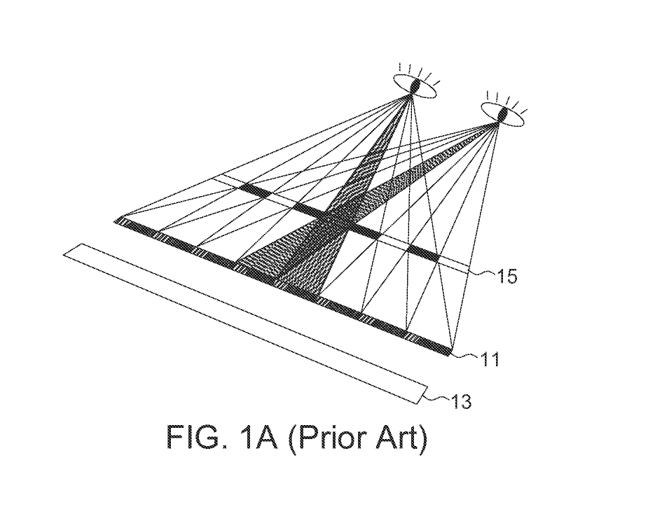

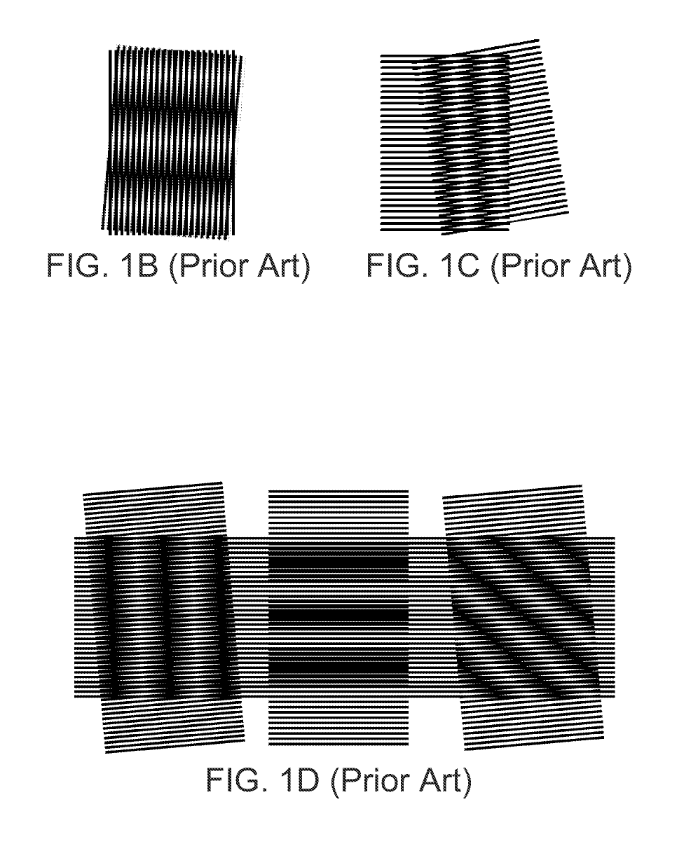

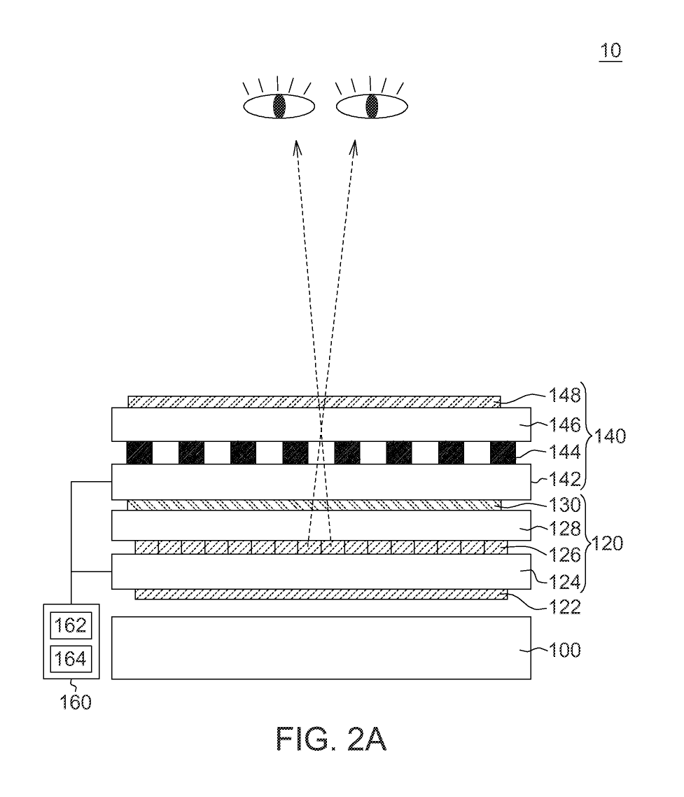

### DETAILED DESCRIPTION OF THE INVENTION

### First Embodiment

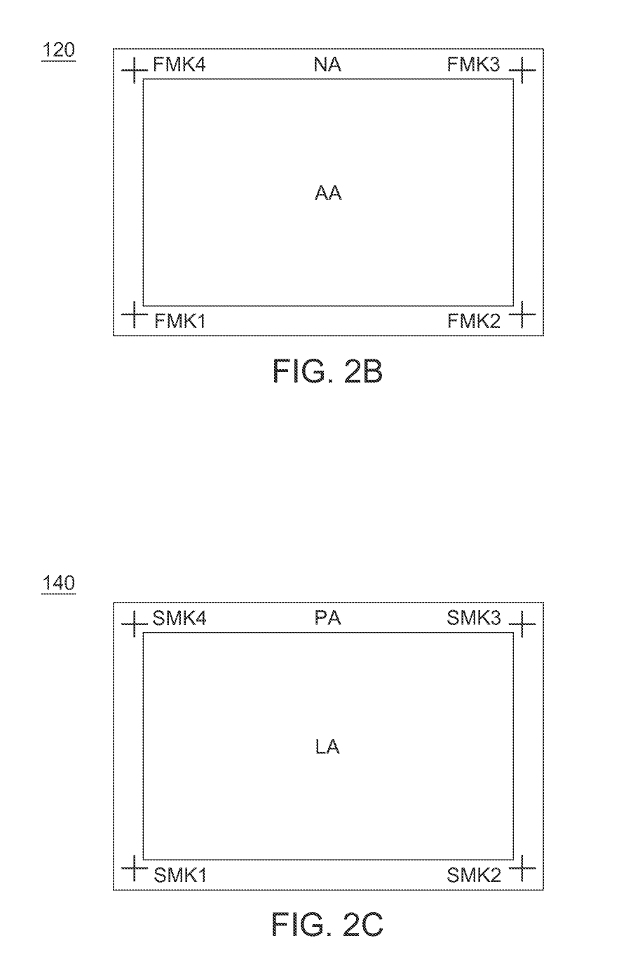

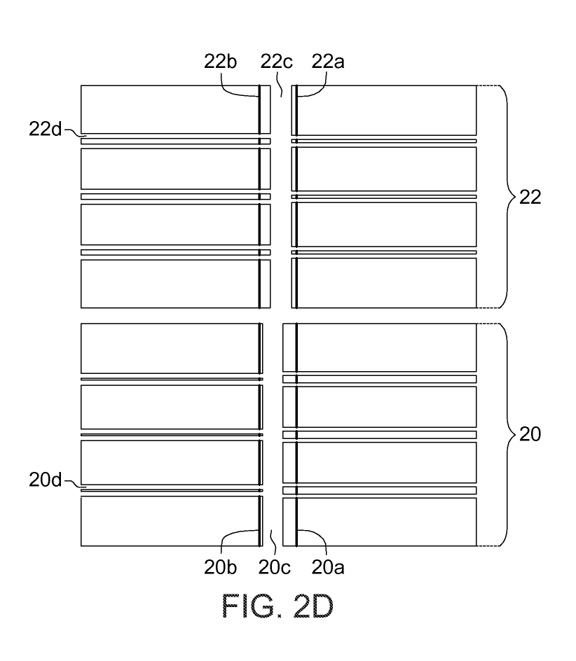

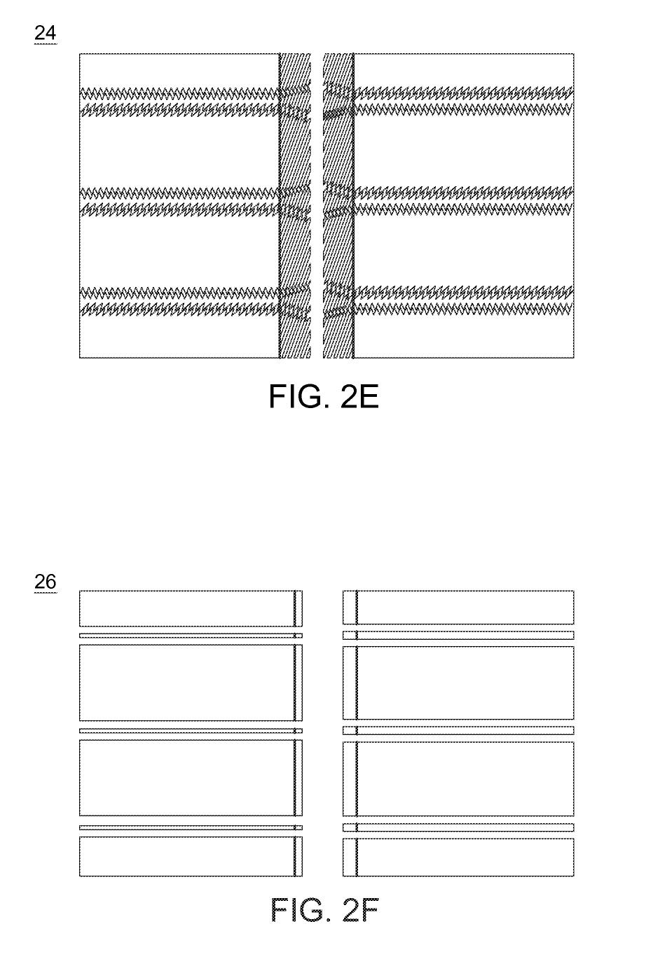

Referring to FIG. 2A, a 2D/3D switchable 2D/3D switchable display device 10 according to an embodiment of the invention is shown. As indicated in FIG. 2, the 2D/3D switchable display device 10 comprises a backlight module 100, a display module 120, an optical control module 140 and a driving module 160. In the present embodiment, the optical control module 140 is exemplified by parallax barrier design. The display module 120 is located at one side of the optical control module 140, and the position of the display module 120 and that of the optical control module 140 are exchangeable. In the present embodiment, the optical control module 140 is disposed between the display module 120 and the viewer, and the display module 120 is disposed between the optical control module 140 and the backlight module 100. In other embodiments, the position of the display module 120 is exchangeable with that of the optical control module 140. The display module 120 and the optical control module 140 can be electrically connected to the driving module 160 separately or jointly. The display module 120 receives a driving signal (pixel information) from the driving module 160 to display a 2D or 3D frame. The optical control module 140 receives another driving signal from the driving module 160 to switch 2D/3D mode. That is, the optical control module 140 can be used as a grating (in 3D mode) or a transmission plate (in 2D mode). The display module 120 comprises a first polarizer 122, a first substrate 124, a display layer 126, a second substrate 128 and a second polarizer 130.

The first substrate 124, such as a thin film transistor array substrate, uses glass, plastics or metal foil as a base material. The thin film transistor array, pixel electrodes and wires are formed on the base material by using thin film and yellow light technology for driving the display layer 126 of the display module 120. The active layer of the thin film transistor may be formed by low-temperature poly-silicon (LTPS), transparent metal oxide semiconductor (TAOS), or amorphous silicon (a-Si). The structure of the thin film transistor may be top gate, bottom gate, dual gate or coplanar. A plurality of thin film transistors is connected to the pixel electrodes and wires to form a pixel array for driving the display layer 126. The pixel electrodes and the wires may be formed by a metal (such as Al, Ag, Mo, Ti, Mn, Cr, Cu, Au, and so on), a metal oxide semiconductor (such as ITO, IZO, and so on), a composite laminate structure formed by a plurality of metals or metal oxide semiconductors, or an alloy formed by a plurality of metals.

The second substrate 128, such as a color filter array substrate or a protection plate, uses glass, plastics or metal foil as a base material. The color filter array, electrodes, wires, and black matrix are formed on the base material by using thin film and yellow light technology (the color filter array can also be formed besides the first substrate 124). The black matrix such as comprises chromium (Cr) or resin. The pixel electrodes and the wires may be formed by a material similar to the material of the first substrate 124, and the similarities are not repeated here. The position of the first substrate 124 and that of the second substrate 128 are exchangeable. The substrate adjacent to the viewer must be formed by a transparent base material. The first substrate 124 or the second substrate 128 may be selectively collocated with an in-cell touch sensor structure, an on-cell touch sensor structure or an out-cell touch sensor structure for providing touch function to the 2D/3D switchable display device 10.

The display layer 126 can be realized by a liquid crystal layer, an organic excitation light emitting diode (OLED) matrix, or an inorganic light emitting diode (LED) matrix. In an embodiment, the display layer 126 can be formed by twist nematic liquid crystal, vertical alignment liquid crystal, in-plane switching liquid crystal or blue phase liquid crystal, and is operated by the voltages of the electrode matrix on both sides of each pixel unit. The direction of the polarized penetration axis of the first polarizer 122 is perpendicular to that of the second polarizer 130. In another embodiment, the display layer 126 is a diode element unit matrix formed by at least two electrode layers clamping a laminated organic/inorganic excitation light emitting layer. In the present embodiment, the display layer 126 is self-luminous, so the 2D/3D switchable display device 10 is not equipped with the backlight module 100, and the first polarizing film 122 or the second polarizing film 130 can be selectively omitted. Through the adjustment of voltage or current, the luminous intensity of the display layer 126 may be changed to display a grey level frame.

The optical control module 140 comprises a third substrate 142, a dielectric layer 144, a fourth substrate 146 and a third polarizer 148. The third substrate 142 and the fourth substrate 146 use transparent glass or plastics as a base material. The electrode array, the wires and the shielding layer (selective) are formed on the base material by using thin film and yellow light technology. The dielectric layer 144b can be realized by such as a liquid crystal layer. An optical controlling element array (pixel/sub-pixel) is formed by the third substrate 142 electrode array, the dielectric layer 144 and the fourth substrate 146 electrode array. Through the adjustment of voltages of the electrodes on the two sides of the dielectric layer 114 of the optical controlling elements, the state of the light passing through each of the optical controlling elements can be controlled to achieve grating effect. For example, the light may completely pass through or may be completely absorbed by the optical controlling elements. The direction of the polarized penetration axis of the third polarizer 148 is perpendicular to that of the second polarizer 130. The optical control module 140 can be aligned and assembled to the display module 120 by using sealant, optical glue or other adhesives. Alternatively, the optical control module 140 and the display module 120 may be positioned by using a plastic frame, so that their relative positions are maintained.

The driving module 160 comprises a driving unit 162 and a correction unit 164. The driving unit 162 is used for transmitting a driving signal required by the display module 120 and the optical control module 140, wherein the driving signal includes information is such as scanning information, common voltage information and pixel information. The correction unit 164 executes the storage, computation, comparison and matching of column data, and adjusts the driving signal outputted from the driving unit 162. The correction unit 164 comprises a processor (not illustrated), a storage device (not illustrated), a signal generator (not illustrated) and an adjustment device (not illustrated). The driving unit 162 and the correction unit 164 do not have to be located in a specific space at the same time or located at specific positions of the 2D/3D switchable display device 10.

In the present embodiment, after the optical control module 140 and the display module 120 are assembled together, with a bias voltage being applied to the electrodes on two sides of the dielectric layer 144 of each optical controlling element, the dielectric layer 144 can be adjusted to generate different arrangements to achieve a transparent mode and a non-transparent mode and used as a switchable grating. Through the adjustment of the bias applied to the optical control module 140, the 2D/3D switchable display device 10 can achieve a 2D/3D switchable function. In an embodiment, the 2D/3D switchable function can be achieved through the use of an active lens. A lens layer and a liquid crystal panel (such as a TN liquid crystal panel) are integrated and used as an optical control module. During the operation of 2D display, the liquid crystal panel, through suitable design, can displacement the light refraction effect generated by the lens layer, avoid the penetrating light being affected by the optical control module and normally display 2D images. During the operation of 3D display, the active lens has the effect of a lenticular lens. In an embodiment, the optical control module 140 can be replaced with an ordinary lenticular lens surface mounted device (SMD) or an ordinary grating SMD on which transparent areas and shielding areas are alternately arranged, but the invention is not limited thereto. However, the 2D/3D switchable display devices lacking function adjusting grating or lenticular lens SMD cannot be switched from 3D display to 2D display.

Referring to FIGS. 2B and 2C, a top view of a display module 120 and a top view of an optical control module 140 according to an embodiment of the invention are respectively shown. As indicated in FIG. 2B, the display module 120 comprises a display area AA and a non-display area NA. The display area AA comprises a pixel unit (not illustrated, such as a liquid crystal unit/sub-unit) for displaying a frame. The non-display area NA comprises several first alignment patterns FMK1˜FMK4. The first alignment patterns FMK1˜FMK4 can be cross-shaped, square-shaped, I-shaped, window-shaped, and so on, at least one side is a stripe. As indicated in FIG. 2C, the optical control module 140 comprises an optical control area LA and an edge area PA. The optical control area LA comprises an optical controlling element (not illustrated) for adjusting 2D or 3D display. The edge area PA comprises several second alignment patterns SMK1˜SMK4. The second alignment patterns SMK1˜SMK4 can be cross-shaped, square-shaped, I-shaped, window-shaped, and so on, and at least one side is a stripe. The size of the display area AA and that of the optical control area LA do not need to be the same, and the pitch between the pixel units and that between the optical controlling elements do not need to be the same either as long as excellent 2D or 3D display can be achieved. The sizes and shapes of the first alignment patterns FMK1˜FMK4 do not need to have the same as that of the second alignment patterns SMK1˜SMK4 as long as the first alignment patterns FMK1˜FMK4 and the second alignment patterns SMK1˜SMK4 can be aligned to each other.

FIG. 2D shows a schematic diagram of an alignment pattern according to an embodiment of the invention. In the present embodiment, the alignment process is performed without using any physical alignment pattern (such as a first alignment pattern FMK or a second alignment pattern SMK . . . , and so on). Instead, the alignment process uses the characteristics of the display frame of the display module 120 and the optical control module 140. During the alignment process, the display module 120 receives a corresponding alignment image from the driving module 160. The alignment image is formed from N view alignment patterns, wherein partial information is taken from each of the N view alignment patterns according to the design of the optical control module 140 to form the alignment image. Through a specific arrangement, a single view alignment pattern can be obtained by observing the alignment image from a particular view angle through the optical control module 140. In theory, if the display module 120 and the optical control module 140 are precisely aligned, the viewer (lens) can observe a particular single view alignment pattern from different view angles through the light permeable portions of the grating formed from the optical controlling elements of the optical control module 140, and the remaining portions are blocked by the grating. Although there may be slight interferences between view alignment patterns, the obtained result is very close to a single view alignment pattern. If the display module 120 and the optical control module 140 are misaligned, what the viewer (lens) views from different view angle through the grating is not a particular single view alignment pattern but an image with multi-view alignment patterns stacking together. The image has blurred edges, enlarged size and twilled lines. FIG. 2D only illustrates the alignment patterns of two views, that is, a view alignment pattern 20 and a view alignment pattern 22, for simplification purpose. The view alignment pattern 20 comprises a 2D alignment pattern 20a, a 2D alignment pattern 20b, a 3D alignment pattern 20c, and a 3D alignment pattern 20d. Moreover, the view alignment pattern 22 comprises a 2D alignment pattern 22a, a 2D alignment pattern 22b, a 3D alignment pattern 22c, and a 3D alignment pattern 22d. When the viewer views the image from different view angle, there is no relative shift or relative width difference between the 2D alignment pattern 20a, the 2D alignment pattern 20b, the 2D alignment pattern 22a, and the 2D alignment pattern 22b. In contrast, there is a relative shift or a relative width difference between the 3D alignment pattern 20c and the 3D alignment pattern 22c, and a relative shift or a relative width difference between the 3D alignment pattern 20d and the 3D alignment pattern 22d. The 2D alignment pattern, the 3D alignment pattern, and other portions can be differentiated from one another other by displaying different grey levels. When the optical controlling elements of the optical control module 140 are a twilled grating, the alignment image can be formed by combining twilled images alternately taken from the view alignment pattern 20 and view alignment pattern 22 at an equal interval and free of overlapping.

The 2D alignment patterns 20a, 20b, 22a and 22b provide an alignment reference. During the alignment display, the relative shift and the relative width change between the 2D alignment patterns 20a, 20b, 22a and 22b observed from different view angles through the grating are close to 0. Ideally, assuming the display module 120 and the optical control module 140 are precisely aligned and the viewer (lens) views the 3D alignment patterns 20c, 20d, 22c and 22d of adjacent view alignment pattern 20 and view alignment pattern 22 through the optical controlling elements (grating) of the optical control module 140, what can be seen by the viewer is only the 3D alignment pattern of one of the view alignment pattern 20 or the view alignment pattern 22, such as the 3D alignment pattern 20c and the 3D alignment pattern 20d of the view alignment pattern 20. On the other hand, assuming the display module 120 and the optical control module 140 are misaligned and the viewer views the image through the optical controlling elements (grating) of the optical control module 140, the viewer may view a mixed image formed from the view alignment pattern 20 and the view alignment pattern 22. Due to the relative shift and the relative width change between the 3D alignment patterns of different view alignment patterns, the 3D alignment patterns viewed by the viewer may be shifted, blurred, having expanded edges, or zigzag images (due to optical diffraction and interference).

FIG. 2E shows a schematic diagram of an alignment image with misalignment according to an embodiment of the invention. As indicated in FIG. 2E, in the alignment step, the image frame 24 is formed with zigzag patterns and expanded width, representing the display module 120 and the optical control module 140 being misaligned. FIG. 2F shows a schematic diagram of an alignment image with precision alignment according to an embodiment of the invention. In FIG. 2F, the image frame 26 displays only the view alignment pattern 20, excluding the zigzag patterns, with precision alignment.

In the present embodiment, the 2D alignment patterns 20a, 20b, 22a and 22b form a vertical line, while the 3D alignment patterns 20c, 20d, 22c and 22d form staggered cross shapes for the purpose of horizontal and vertical alignment. However, the invention is not limited thereto. Alternatively, 2D alignment patterns can be disposed in the horizontal direction, and the 2D alignment patterns or the 3D alignment patterns may have different shapes.

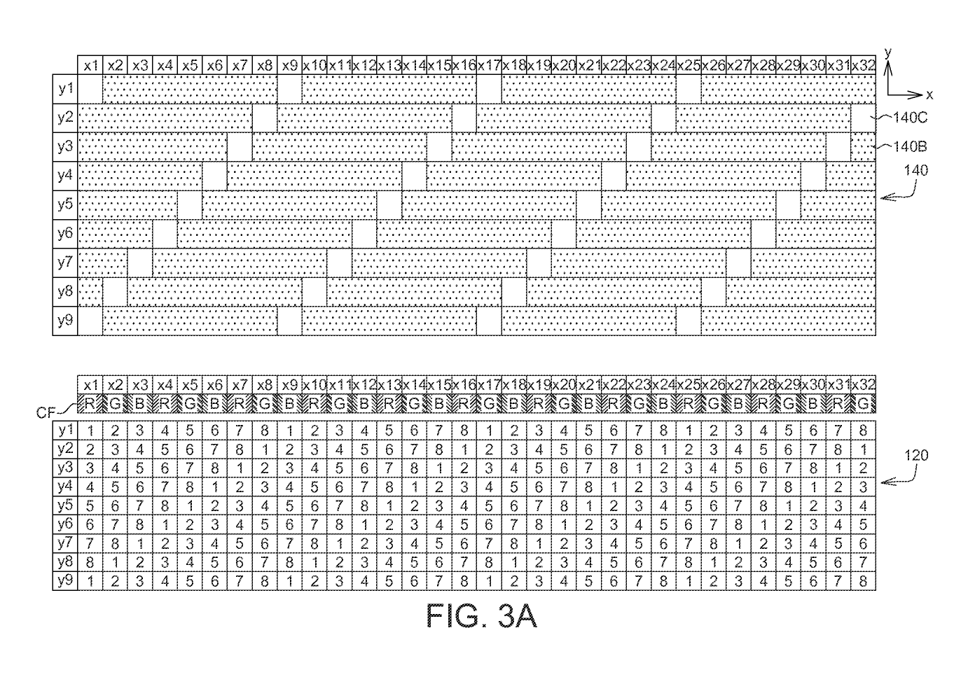

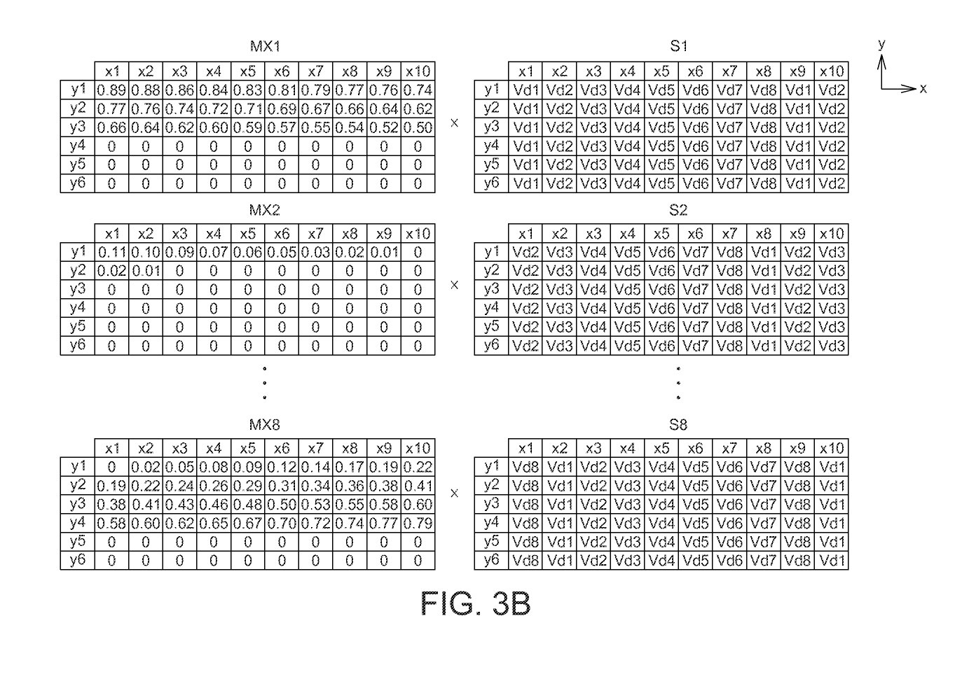

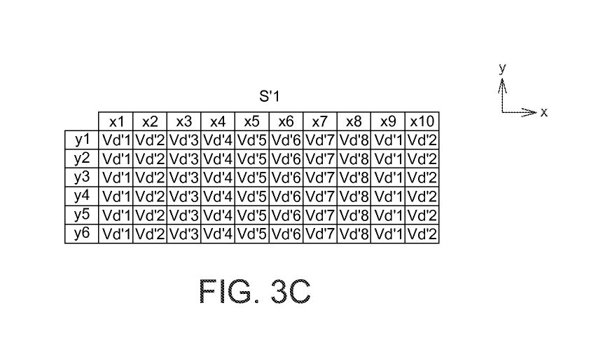

Referring to FIG. 3A, a schematic diagram of the pixel information (display frame) of a display module 120 and patterns of an optical control module 140 according to an embodiment of the invention (denoted by a portion of a matrix) is shown. As indicated in FIG. 3A, the optical control module 140 can display a periodic grating pattern formed from the transparent areas 140C and the shielding areas 140B alternately arranged in such as a step-like periodic pattern. In other embodiments, the transparent areas 140C and the shielding areas 140B may also be arranged in a striped pattern, a slant pattern, a mosaic pattern or a zigzag pattern, and the invention is not limited thereto. In FIG. 3A, position x1, x2 . . . and position y1, y2 . . . denote the position numberings of the transparent area 140C and the shielding area 140B corresponding to the horizontal x-axis and the vertical y-axis of the optical control module 140. In addition, the position numberings of the pixel information corresponding to the horizontal x-axis and the vertical y-axis of the display module 120 may also be denoted by positions x1, x2 . . . and positions y1, y2 . . . . In the following descriptions, the positions x(i) and y(j) denote the position numbering of each accessory element in the horizontal x-axis and vertical y-axis of each module/device, wherein i and j both are a positive integer, i=1˜m, j=1˜m′, and m and m′ and are related to the resolution or the matrix size of each element of a module/device. A color film CF denotes the corresponding RGB colors displayed by the pixel information.

The present embodiment is exemplified by 8 viewing angles. Referring to each row of the periodic grating pattern of the optical control module 140, the ratio of the length of the transparent area 140C to the length of the shielding area 140B is substantially 1:7. In other words, one transparent area 140C occurs in every 8 absolute positions, and the occurrence period for the transparent area 140C is 8. In collocation with the period of the optical control module 140, the period of the pixel information of the display module 120 is also 8. The embodiment of the invention can be used in any multi-view 2D/3D switchable display device having more than 2 viewing angles, the period of the optical control module 140 does not have to be the same as that of the display module 120, and the invention is not limited thereto.

FIG. 3B shows computation tables MX1˜MX8 and view matrix tables S1˜S8 according to an embodiment of the invention. The arrangement of the transparent area 140C and the shielding area 140B is exemplified by columns (the linear type, different from that in FIG. 3A). The computation tables MX1˜MX8 and the sizes of the initial view matrix tables S1˜S8 are related to the resolution of the 2D/3D switchable display device. FIG. 3B only illustrates a portion of the table content.

Referring to FIG. 3B. To represent the 3D image of an object, N view frames V1˜VN (not illustrated) of the image need to be shot. The view frames V1˜VN are the original images of the object shot at N angles, and between which there are consecutive angle changes and parallax. When the viewer's two eyes respectively obtain two different view frames, a 3D display effect can be created. For example, in a forward mode, a 3D image is formed when the left eye receives the view frame V1 information and the right eye receives the view frame V3. Or, in a reverse mode, a 3D image is formed when the left eye receives the view frame V3 and the right eye receives the view frame V1. Although a 3D image can also be created in a reverse manner, the 3D effect obtained in a reverse manner is different from that obtained in a forward manner. If 3D images are immediately received in a reverse mode followed by in a forward mode, then jumping would occur between images and cause discomfort to the viewer. Of the view frames V(N), the two view frames V1 and VN at the edges are shot while the view frames V2˜V(N−1) between V1 and VN can be obtained by way of interpolation. Each view frame V has T view frame positions, and each view frame position has a view pixel information Vd(N). For example, the first view frame V1 has T view frame positions, and each view frame position has a view pixel information Vd1, wherein N is a positive integer greater than 2, T is a positive integer denoting the product of the x-axis number m and the y-axis number m′, and m and m′ both are a positive integer. The storage device (not illustrated) has N initial view matrix tables S1˜SN stored therein. Each initial view matrix table S(N) has T view matrix table positions for receiving the view pixel information Vd(N) selected in a particular way. The column number and row number of each view matrix are the same as that of the view frame V(N). For example, when the number of view frames V is 8, the storage device stores 8 initial view matrix tables S1˜S8 having different arrangements of view pixel information Vd(N). Any one initial view matrix table S(N) can be used as a pixel information (data frame) directly outputted to the display module 120 for 3D display.

One of the methods of applying the view pixel information Vd(N) to corresponding initial matrixes to generate a view matrix table S(N) is disclosed below, and only a portion of the content is illustrated for explanation purpose. As indicated in FIG. 3B, the number of view frames V is 8, and the light permeating direction of the grating is vertical (striped pattern, the direction of the columns). The view pixel information Vd1 in the first column position x1 and the ninth column position x9 of the first view frame V1 are applied to the first column position x1 and the ninth column position x9 of the view matrix table of the initial view matrix table S1. Likewise, the view pixel information Vd2 in the second column position x2 and the tenth column position x10 of the second view frame V2 are applied to the second column position x2 and the tenth column position x10 of the view matrix table of the initial view matrix table S1. By repeating the above steps, a full first initial view matrix table S1 is finished. The difference between the initial view matrix tables S1˜S8 lies in the way of applying the view pixel information Vd(N) to the positions in the view matrix table (horizontal shift). In other words, the F^{th} column view pixel information VdF of the F^{th} view frame VF is applied to the (F+zN)^{th} column of the view matrix table position of the first initial view matrix table to obtain the first initial view matrix table S1; the F^{th} column view pixel information Vd(F+1) of the (F+1)^{th} view frame V(F+1) is applied to the (F′+zN)^{th} column of the view matrix table position of the second initial matrix table S2. The operation is performed by the same analogy until all N view matrix tables are finished, wherein F is a set of positive integers ranging from 1 to N, F comprises 1 and N, z is a set of positive integers larger than or equal to 0, and the upper limit of z is related to the frame resolution (sizes). The method for obtaining the view information by way of columns is not for limiting the invention, and the view information can also be sampled by rows, slant lines, along a zigzag shape or even from irregular arranged points.

The signal generator of the correction unit 164 is used for generating N computation tables MX(N), wherein N denotes the number of viewing angles, and the number of the computation tables MX(X) is equal to the number of the initial view matrix tables S(N). The adjustment device in the correction unit 164 inputs an adjustment parameter to the processor computation for adjusting the content of the computation table. For example, since 8 viewing angles are exemplified in the present embodiment, 8 dot matrix multiplication tables MX1˜MX8 are generated. The computation tables MX1˜MX8 respectively correspond to the initial view matrix tables S1˜S8. That is, the computation table MX1 corresponds to the initial view matrix table S1, and the computation table MX2 corresponds to the initial view matrix table S2. The operation is performed by the same analogy. Each of the computation tables MX1˜MX8 has the same numbers of columns and rows as that of each of the initial view matrix tables S1˜S8. The view matrix table position in each initial view matrix table S(N) corresponds to a weight information at the same position in a computation table MX. Each computation table MX(N) has a plurality of weight information MXd. The weight information MXd can be adjusted by the user, and the design of the weight information MXd is related to the sizes of the transparent areas 140C and the shielding areas 140B of the optical control module 140, the pixel/sub-pixel size of the display module 120 or the relative distance of the optical control module 140. Here, relative distance is such as a ratio of the length of the transparent area 140C to the length of the shielding area 140B. In the present embodiment, the sum of the weight information MXd of the same position (Cartesian coordinates) of the computation tables MX1˜MX8 is smaller than or equal to 1. For example, the sum of the weight information MXd at the position (x1,y1) of computation tables MX1˜MX8 is equal to the sum of (0.89+0.11+ . . . +0) and is smaller than or equal to 1. Then, the processor performs dot matrix multiplication on the initial view matrix tables S1˜S8 and the computation tables MX1˜MX8, and calculates the sum of the products of the view pixel information Vd(N) at each coordinate position in the initial view matrix table S(N) and the weight information MXd corresponding to the same coordinate position to output an adjusted view matrix information S′(N) as the outputted pixel information (frame). The view pixel information Vd′(N) in the adjusted view matrix information S′(N) are weighted information and are not the original view pixel information Vd(N).

FIG. 3C shows an adjusted first view matrix S′1. The pixel information Vd′1′ of the adjusted first view matrix S′1 at the position (x1, y1) is equal to the product of the weight information MXd of the computation table MX1 at the position (x1, y1) and the view information Vd1 of the first initial view matrix table S1 at the position (x1, y1) plus the product of the weight information MXd of the computation table MX2 at the position (x1, y1) and the view information Vd2 of the second initial view matrix table S2 at the position (x1, y1). The summation of products obtained by sequentially calculating the products until the product of the weight information MXd at the position (x1, y1) of the last computation table MX8 and the view pixel information Vd8 of the eighth initial view matrix S8 at the position (x1, y1) is added to the calculation. Therefore, the view pixel information Vd′1 is expressed as: Vd′1=0.89×Vd1+0.11×Vd2+ . . . +0×Vd8. By the same token, the information at other coordinates can be obtained. The formula is expressed as:

$${Vd}_{( x , y )}^{′} = {\sum }_{n = 1}^{N} [ {MXd ( n )}_{( x , {y}^{′} )} \times {Vd ( n )}_{( x , y )} ] ( x = 1 \sim m ; y = 1 \sim {m}^{′} ;$$

view angle 1˜N). There is no interactive calculation between information at different coordinates. In other words, matrix dot multiplication is not an ordinary matrix multiplication or other calculations such as inner product, outer product and transposition. The following calculations hereinafter are as described above.

In the present embodiment, through the addition and transformation of function, such that each view matrix table position in the adjusted view matrix information table comprises the sum of more than one view pixel information weighted by different weight information. The adjusted pixel information obtained by using the adjusting algorithm of the present embodiment provides better 3D image to the viewer.

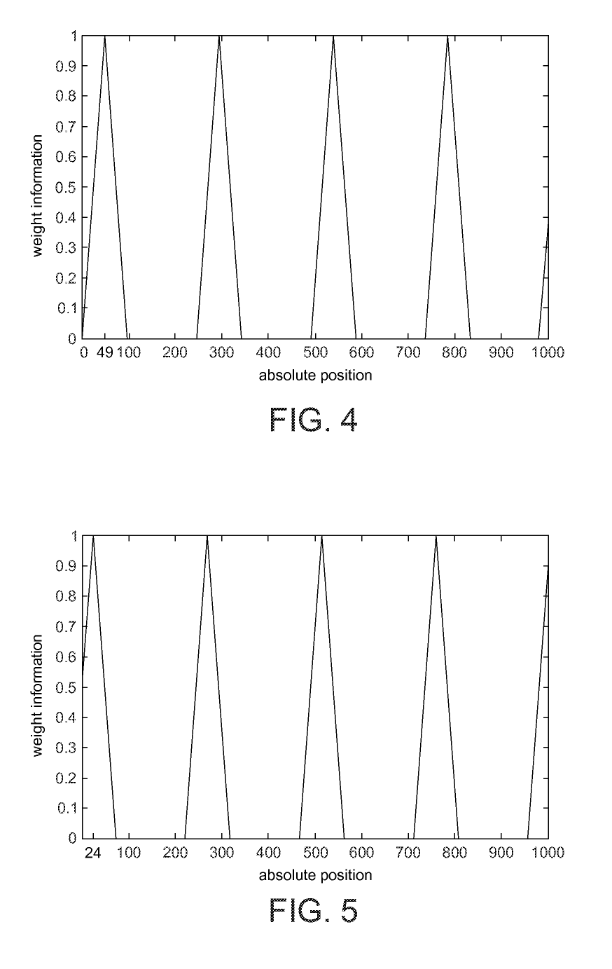

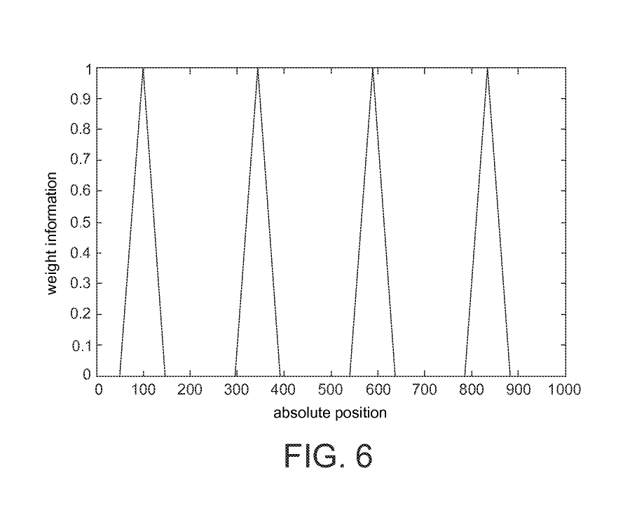

FIGS. 4˜6 illustrate wave patterns of experimental data of a 5-view (N=5) computation table MX(N) according to an embodiment of the invention. The x-axis denotes the corresponding horizontal x-axis absolute position in the computation table MX(N), and the y-axis denotes the weight information MXd(N). In the computation table of the present embodiment, two adjacent computation tables have a specific shift (may be equidistant shift or non-equidistant shift), and the wave patterns for each row of each computation table MX(N) also has a specific shift (may be equidistant shift or non-equidistant shift). Details of the wave pattern are disclosed below.

As indicated in FIG. 4, the wave pattern of the weight information MXd1 assigned to the first row y1 of the first computation table MX1 is such as a triangular wave. The period of the first triangular wave starts from the original point (x=0). The peak of the first triangular wave corresponds to the position (49,1), which means that the view frame information Vd(1) at the position (49,1) of the first initial view matrix table S1 needs to be weighted by 1. In addition, the duty period of each triangular wave is 98. The wave pattern of the weight information MXd(N) of the computation table MX(N) can also be the wave pattern of any periodic function, such as a triangular wave, a sine wave or a squared wave, and the invention is not limited thereto.

FIG. 5 shows a wave pattern of the weight information MXd1 assigned to the second row y2 of the first computation table MX1 and its corresponding absolute position. As indicated in FIG. 5, the peak of the first triangular wave of the weight assigned to the second row corresponds to a position at which the y-axis is 1 and the x-axis is 24, which means that the view frame information Vd(N) at the position (24,1) of the first initial view matrix table S1 needs to be weighted by 1.

Referring to FIGS. 4 and 5 at the same time. In the same computation table MX(N), the wave pattern of the weight information MXd(N) of two adjacent rows has a first phase shift. For example, in comparison to the x-axis position of the peak of the first triangular wave of FIG. 4, which is 49 (which denotes the weight information MXd1 of the second row of the first computation table MX1), the x-axis position of the peak of the first triangular wave of FIG. 5 is 24 (which denotes the weight information MXd1 of the first row of the first computation table MX1), and is shifted to the left by 25.

FIG. 6 shows a wave pattern of the weight information MXd2 assigned to the first row y1 of the second computation table MX2 and its corresponding absolute position. As indicated in FIG. 6, the wave pattern of the weight information MXd2 assigned to the first row y1 of the second computation table MX2 is a triangular wave. The peak of the first triangular wave corresponds to a position (99,1), which means that the view pixel information Vd2 at the position (99,1) of the second initial view matrix table S2 needs to be weighted by 1. In addition, the wave pattern of the duty period of the weight information MXd2 at each row of the second computation table MX2 is the same as that of the weight information MXd1 at each row of the first computation table MX1.

In the present embodiment, the wave patterns of the weight information MXd(N) of the same row corresponding to two adjacent computation tables MX(N) have a second phase shift. Referring to FIGS. 4 and 6 at the same time, in comparison to the x-axis coordinate of the peak of the first triangular wave of FIG. 4, which is 49 (denoting the weight information MXd1 in the first row of the first computation table MX1), the x-axis coordinate of the peak of the first triangular wave of FIG. 6 is 98 (denoting the weight information MXd2 in the first row of the second computation table MX2), and is shifted to the right by 49. The second displacement shifted to the right is the map shift of each computation table MX(N). Therefore, suppose the second displacement is fixed as 49, when the number of viewing angles is 5, the map shift of the wave pattern of the weight information MXd of the same row of the fifth computation table MX5 and the first computation table MX1 is 196 (equivalent to 4 times of the second phase shift of 49), and is exactly equal to the period of the triangular wave. To summarize, the algorithm of the present embodiment of the invention makes each weighted and adjusted view pixel information Vd′ at the view angle matrix position in the adjusted view matrix table S′ comprises the sum of more than one view pixel information Vd weighted by different proportions. The adjusted view matrix table S′ obtained by using the adjusting algorithm is outputted to the display module 120 to increase 3D display effect.

Moreover, the method of adjustment by using an algorithm reduces the occurrence of X-talk arising due to the error in the assembly and alignment process of the display module 120 and the optical control module 140. In the manufacturing process of the 2D/3D switchable display device 10 of the present embodiment of the invention, moving alignment error and rotation alignment error (angle φ error) may occur during the assembly process of the optical control module 140 and the display module 120, wherein the rotation alignment error can cause severe X-talk to the left eye and the right eye, and preferred stereoscopic images cannot be generated. Without changing the relative position between the display module 120 and the optical control module 140 or rotation alignment error (without changing the structural conditions), the above-mentioned algorithm can be used to compensate and adjust the view pixel information Vd in the initial view matrix table S to provide an adjusted view matrix table S′, hence reducing X-talk and increasing the effect of stereoscopic image (by using the signal adjustment method). The experimental results of compensating and adjusting the view pixel information Vd in the initial view matrix table S by using algorithm are illustrated in Table 1.

TABLE 1

| | Adjusted X-talk | Un-adjusted X-talk |
|---|---|---|
| Angle φ = 0° (reference value) | 0.963668 | 0.963668 |
| Angle φ = 1.206° | 0.996559 | 3.432237 |
| Angle φ = 3.367° | 0.972545 | 4.926526 |
| Angle φ = 4.399° | 1.176128 | 4.905386 |
| Angle φ = 12.043° | 1.246652 | 4.917623 |
| Angle φ = 15.734° | 1.241016 | 4.878003 |

Referring to Table 1. In general, when the display module 120 and the optical control module 140 are assembled by way of precision alignment, the unadjusted X-talk corresponding to the angle φ between 0° and 1.206° can be obtained from a linear calculation of the unadjusted X-talk=0.96 corresponding to angle φ=0° and the unadjusted X-talk=3.43 corresponding to the angle φ=1.206° as indicated in Table 1. When the angle φ=0.01°, X-talk=0.984. When the angle φ=0.02°, X-talk=1.004. When the angle φ=0.03°, X-talk=1.025. Based on the above calculation, when product tolerance is given as X-talk<1 (X-talk unrecognizable to the consumers), the angle φ must be smaller than or equal to 0.01°. In other words, the angle φ of the rotation alignment error requested by the 2D/3D switchable display device 10 must be smaller than or equal to 0.01°. The experimental results of Table 1 show that the display device 10 of the present embodiment of the invention may comply with product tolerance, that is, X-talk<1, within the angle φ=0˜3° of rotation alignment error, by using adjustment algorithm, preferred stereoscopic images can be provided to the viewer. If the product tolerance is given as: X-talk<1.5, then the present embodiment of the invention may provide preferred stereoscopic images to the viewers within the angle φ=0˜15° of rotation alignment error.

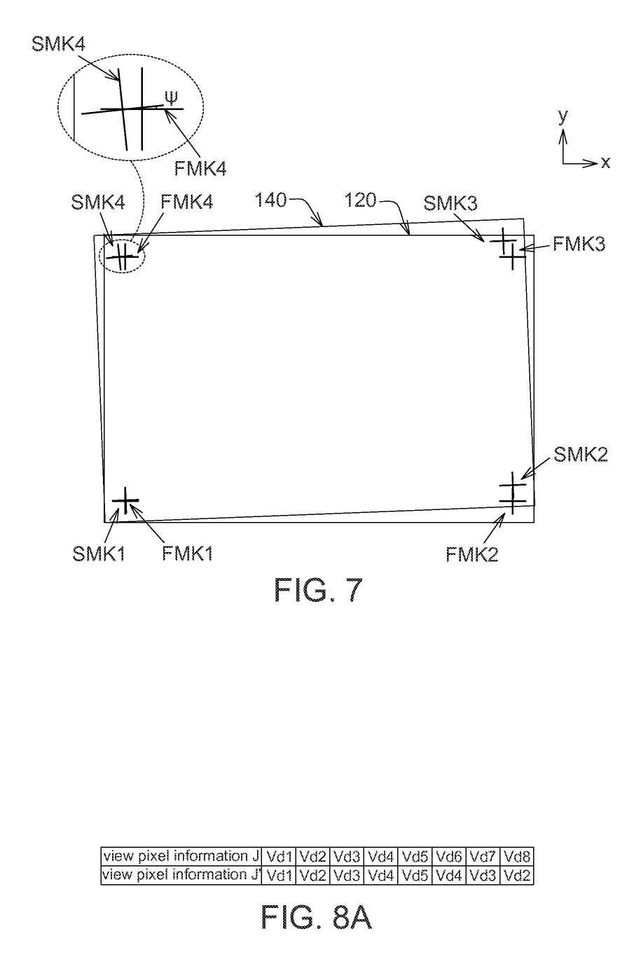

Referring to FIG. 7, a scenario when a 5-inch display module 120 and an optical control module 140 are assembled to each other by way of non-precision alignment is shown. The offset is larger than 0.05 mm, the alignment may be realized by using touch display module alignment machine, optical film alignment machine or manual alignment, and the unit of measure is mm. The display module 120, disposed underneath the optical control module 140, has first alignment patterns FMK1˜FMK4, wherein the coordinates of FMK1 are (0,0), the coordinates of FMK2 are (52,0), the coordinates of FMK3 are (0,29.3), and the coordinates of FMK4 are (52,29.3). The optical control module 140, disposed above the display module 120, has second alignment patterns SMK1˜SMK4, wherein the coordinates of SMK1 are (0,0), the coordinates of SMK2 are (52,0), the coordinates of SMK3 are (0,29.3), and the coordinates of SMK4 are (52,29.3). The first alignment patterns FMK1˜FMK4 of the display module 120 and the corresponding second alignment patterns SMK1˜SMK4 of the optical control module 140 are aligned and assembled to each other. An angle φ (acute angle) and an offset (Δx,Δy)=(y,x)*tan φ are formed between the first alignment patterns FMK1˜FMK4 and the corresponding second alignment patterns SMK1˜SMK4. When the angle φ=0.01°, the coordinates of the offset (Δx,Δy) of the second alignment pattern SMK1 are (0,0), the coordinates of the offset (Δx,Δy) of the second alignment pattern SMK2 are (0,0.00908), the coordinates of the offset (Δx,Δy) of the second alignment pattern SMK3 are (0.00511,0), and the coordinates of the offset (Δx,Δy) of the second alignment pattern SMK4 are (0.00511,0.00908). When the angle φ=0.1°, the coordinates of the offset (Δx,Δy) of the second alignment pattern SMK1 are (0,0), the coordinates of the offset (Δx,Δy) of the second alignment pattern SMK2 are (0,0.09076), the coordinates of the offset (Δx,Δy) of the second alignment pattern SMK are (0.05114,0), and the coordinates of the offset (Δx,Δy) of the second alignment pattern SMK4 are (0.05114,0.09076). Since the precision of alignment is demarcated by the offset (Δx,Δy)=(0.05,0.05), the precision requested by a liquid crystal display LCD during the ODF process normally achieves the level of (Δx,Δy)=(0.005,0.005). Therefore, the angle φ being smaller than 0.1° is normally the margin of error requested by a 2D/3D switchable display device 10. Therefore, in an embodiment, the method of adjusting pixel information by using the algorithm disclosed in the invention is also applicable to rotation alignment error with the angle φ=0˜15°. Preferably, the invention is applicable to the rotation alignment error with the angle φ being larger than 0.1 and smaller than 15°.

### Second Embodiment

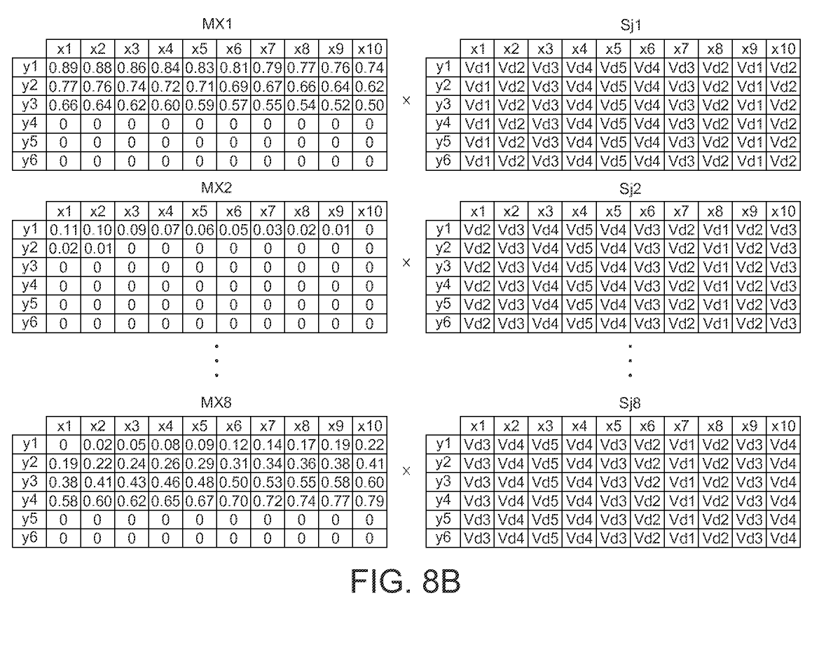

FIG. 8A shows a schematic diagram of the generation of an initial view matrix table Sj(N) according to a second embodiment of the invention. The initial view matrix table S(N) is a matrix table generated by the sampling method of the view pixel information Vd(N) of the first embodiment. The initial view matrix table Sj(N) is another matrix table generated by the sampling method of the view pixel information Vd(N) of the present embodiment. The difference between the two initial view matrix tables S(N) and Sj(N) lies in that in the present embodiment only a portion of the view frame V(N) is used, and the view frames V(N) are numbered and N view frames V(N) are provided by way of reverse replacement. The number of view frames V(N) provided is the same as the number of view angles N. The present embodiment can avoid 3D image jumping which arises when the parallax of the view frames received by the two eyes is reversed. When the number of view angles N is an even number, the number of view frames V(N) sampled is equal to (N/2)+1 (less than the original number of view frames), the ((N/2)+2)^{th} view frame V((N/2)+2) to the N^{th} view frame V(N) are respectively replaced by the (N/2)^{th} view frame V(N/2) to the second view frame V2 which are reversely arranged, and the view pixel information Vd are applied to the view matrix table position to generate the initial view matrix table Sj(N) according to the method of the first embodiment.

As indicated in FIG. 8A, when the number of viewing angles is 8, the view frames V1˜V5 are sampled. Like the first embodiment, the view pixel information Vd1˜Vd5 are applied to the first to the fifth column of the view matrix table Sj1 in a forward mode. However, after the view information V5, the view frame V6˜V8 are replaced by the view frames V4˜V2 which are reversely arranged. That is, the view frame V6 is replaced by the view frame V4, the view frame V7 is replaced by the view frame V3, the view frame V8 is replaced by the view frame V2, and then the view pixel information Vd4˜Vd2 of the view frames V4˜V2 are applied to the positions in the view matrix table position in the same mode used in the first embodiment to finish the initial view matrix table Sj1. The adjusted initial view matrix table Sj1 avoids image jumping which causes discomfort to the viewer. The jumping occurs when the viewer's left eye and right eye sequentially cross the boundary of a viewing angle period (for example, the left eye forwardly jumps to the view pixel information Vd7 from the view pixel information Vd5, and the right eye reversely jumps to the view pixel information Vd2 from the view pixel information Vd8).

FIG. 8B shows computation tables MX1˜MX8 and view matrix tables Sj1˜Sj8 according to a second embodiment of the invention. The weight information stored in the computation tables MX1˜MX8 are such as the same as the weight information MXd1˜MXd8 stored in the computation tables MX1˜MX8 of the first embodiment. The calculation of the weighted and adjusted view pixel information is similar to that of the first embodiment except that the initial view matrix tables S1˜S8 are replaced by the adjusted initial view matrix tables Sj1˜Sj8. The generation of the view matrix tables Sj1˜Sj8 of FIG. 8B replaces the generation of the initial view matrix tables S(N) of the first embodiment with fewer view frames by way of reverse replacement. Then, the processor calculates the sum of the products of each view pixel information Vd(N) of the initial view matrix tables Sj1˜Sj8 and its corresponding weight information and outputs the adjusted view matrix table Sj′(N).

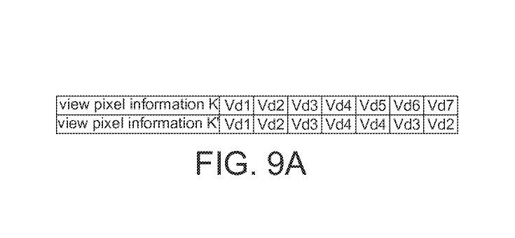

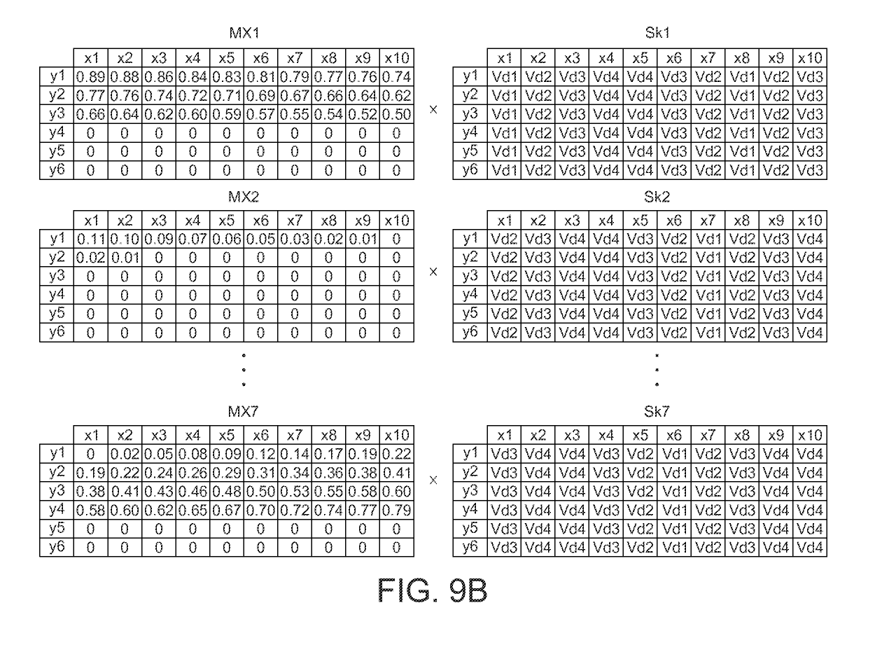

FIG. 9A shows a schematic diagram of the generation of an N-view initial view matrix table Sj(N) according to a second embodiment of the invention wherein N is an odd number. The generation of an initial view matrix table Sj(N) of odd-numbered view angles is similar to the generation of an initial view matrix table Sj(N) of even-numbered view angles except that in the generation of an initial view matrix table Sj(N) of odd-numbered view angles, the number of view frames V(N) sampled is equal to (N+1)/2 (less than the original number of view frames), the (((N+1)/2)+1)^{th} view frame V(((N+1)/2)+1) to the N^{th} view frame V(N) are replaced by the ((N/1)/2)^{th} view frame V((N+1)/2) to the second view frame V2. Then, the initial view matrix table Sj(N) is generated according to the same method used in the first embodiment.

As indicated in FIG. 9A, when the number N of viewing angles is 7, the view frames V1˜V4 are sampled. The view pixel information Vd1˜Vd4 are applied to the first to the fourth column of the initial view matrix table Sj1 in a forward mode, and the view frame V5˜V7 are replaced by the view frames V4˜V2 which are reversely arranged and are then sequentially applied to the fifth to the seventh column to finish the initial view matrix table Sj1. The adjusted initial view matrix table Sj1 avoids image jumping which causes discomfort to the viewer. The jumping occurs when the viewer's left eye and right eye sequentially cross the boundary of a viewing angle period (for example, the left eye forwardly jumps to the view pixel information Vd7 from the view pixel information Vd5, and the right eye reversely jumps to the view pixel information Vd2 from the view pixel information Vd8).

FIG. 9B shows computation tables MX1˜MX7 and view matrix tables Sk1˜Sk7 according to a second embodiment of the invention. The weight information MXd1˜MXd7 stored in the computation tables MX1˜MX7 are the same as the weight information MXd1˜MXd7 stored in the computation tables MX1˜MX7 of the first embodiment. The calculation of the weighted and adjusted view pixel information Vd is similar to that of the first embodiment except that the view matrix tables S1˜S7 are replaced by the initial view matrix tables Sk1˜Sk7. The generation of the initial view matrix tables Sk1˜Sk7 of FIG. 9B replaces the generation of the initial view matrix tables S(N) of the first embodiment with fewer view frames by way of reverse replacement. Then, the processor calculates the sum of the products of each view pixel information Vd(N) of the initial view matrix tables Sk1˜Sk7 and its corresponding weight information and outputs the adjusted view matrix table Sk′(N).

### Third Embodiment

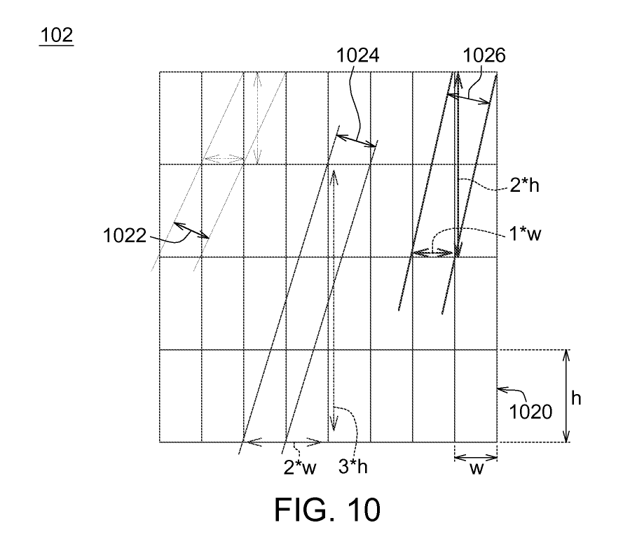

FIG. 10 shows a schematic diagram of a plurality of optical controlling elements 1022, 1024 and 1026 (similar to the transparent area 140C but with a boundary being a straight line) of the optical control module 140 arranged at different arrangement angles according to an embodiment of the invention. As indicated in FIG. 10, the pixel matrix 102 disposed on the display module 120 has a plurality of sub-pixels 1020, each (such as R sub-pixel, G sub-pixel and B sub-pixel) having a length h and a width w. With respect to the sub-pixels 1020, the arrangement of the optical controlling elements 1022 is based on a slope being w/h. With respect to the sub-pixels 1020, the arrangement of the optical controlling elements 1024 is based on a slope being 2w/3h. With respect to the sub-pixels 1020, the arrangement of the optical controlling elements 1026 is based on a slope being w/3h.

In other words, the slope can be expressed as

$$\frac{a \times w}{b \times h} ,$$

wherein a, b both are a positive integer. Moreover, the widths of the optical controlling elements 1022, 1024 and 1026 on the x-axis is slightly smaller than the width w of the sub-pixels 1020 to avoid X-talk interfering with two adjacent images viewed by the viewer. However, to the viewer, the width w of the sub-pixels 1020 mapped on the optical control module 140 is substantially the same as the widths of the optical controlling elements 1022, 1024 and 1026 on the x-axis. If the optical control module 140 and the display module 120 are very close to each other, then the width difference can be neglected. In the following embodiments, the width difference is assumed to be negligible. The arrangement slopes of the optical controlling elements are not limited to the three arrangement slopes exemplified in the above descriptions, and can be any other suitable slopes.

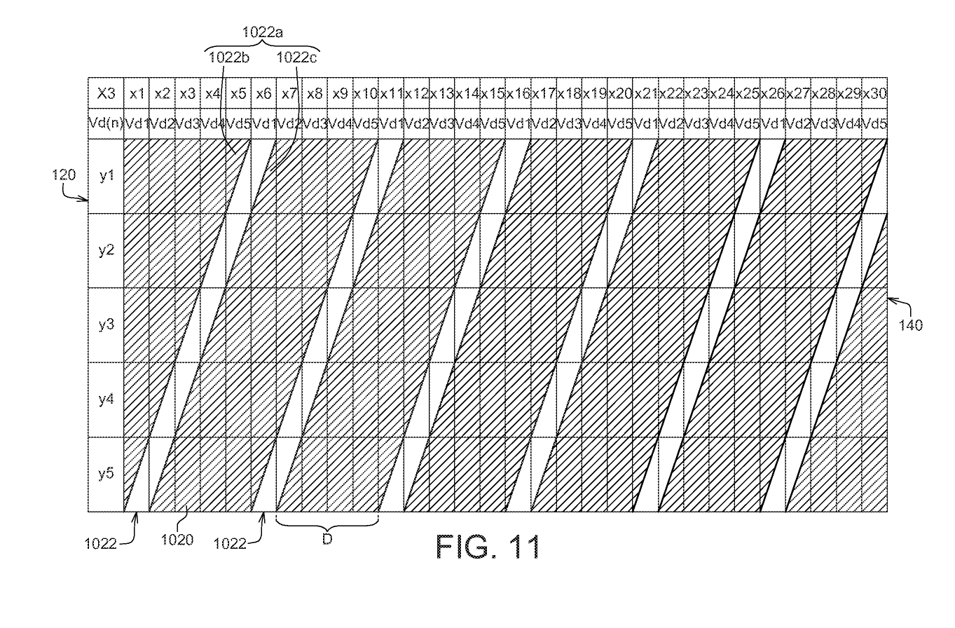

FIG. 11 shows a schematic diagram of the optical controlling elements (such as a transparent area of the grating) arranged with the slope being w/h according to an embodiment of the invention. As indicated in FIG. 11, the optical control module 140 covers the display module 120, and comprises a plurality of optical controlling elements 1022. The distance D between two adjacent optical controlling elements 1022 is the product of the number N of view angles and the width of the optical controlling elements 1022 on the x-axis.

In FIG. 11, the number N of view angles of the display module 120 is 5, the x-axis and the y-axis denote the absolute positions of the sub-pixels 1020 in the horizontal direction and the vertical direction respectively, and the view pixel information Vd1˜Vd5 are repeatedly arranged by columns. In the present embodiment, the relative information is the slope of the arrangement of the optical controlling elements 1022 with respect to the sub-pixels 1020.

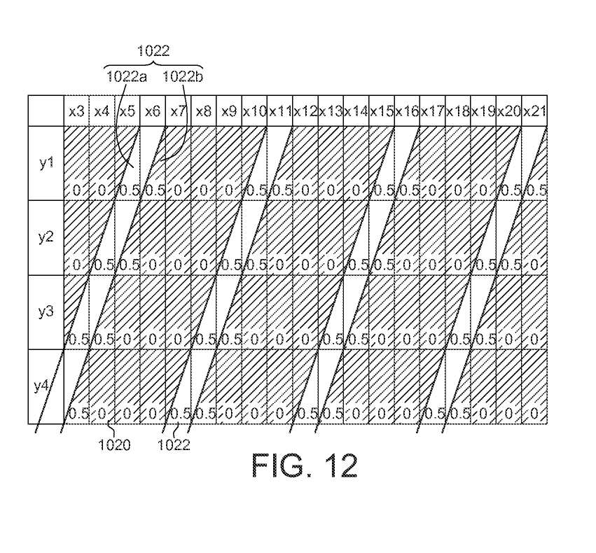

FIG. 12 shows a schematic diagram of the optical controlling elements 1020 arranged with the slope being w/h for providing corresponding weight information according to an embodiment of the invention. In the present embodiment, the slope of the arrangement of the optical controlling elements 1022 with respect to the sub-pixels 1020 is w/h. Since the situation in each row is similar, the analysis of the y1 row is exemplified here. At the x5 position, the first opening 1022a of the optical controlling elements 1022 exposes the sub-pixels 1020 by ½ of the area of the view pixel information Vd5. At the x6 position, the second opening 1022b of the optical controlling elements 1022 exposes the sub-pixels 1020 by ½ of the area of the view pixel information Vd1. Therefore, the weight information assigned to the sub-pixels 1020 having the view pixel information Vd5 is ½, and the weight information assigned to the sub-pixels 1020 having the view pixel information Vd1 is also ½. To obtain better stereoscopic image effect, the view pixel information Vd(N) of the sub-pixels 1020 need to be weighted and adjusted according to the ratio of the areas by which the sub-pixels 1020 correspond to the optical controlling elements 1022.

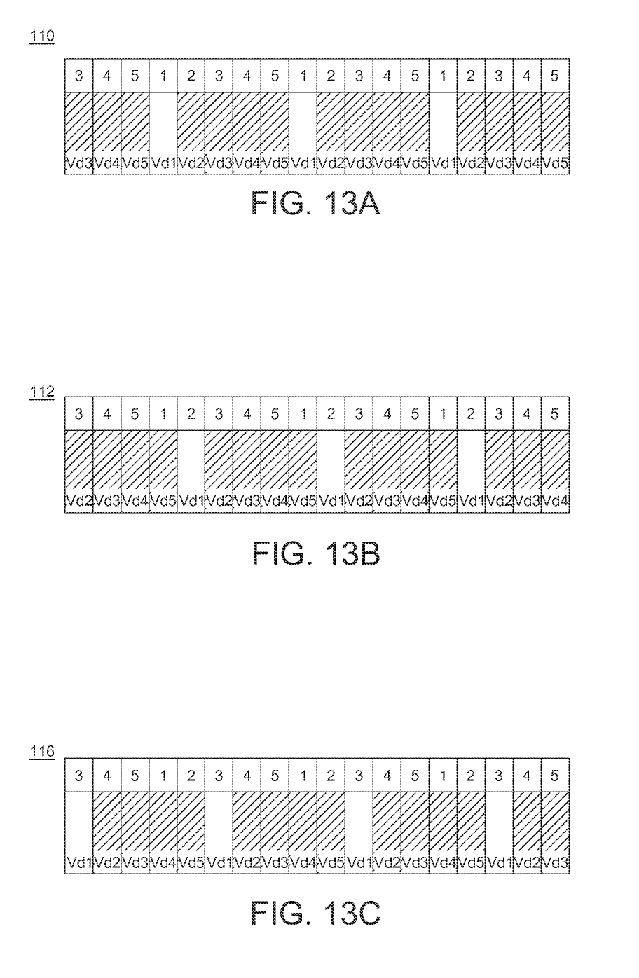

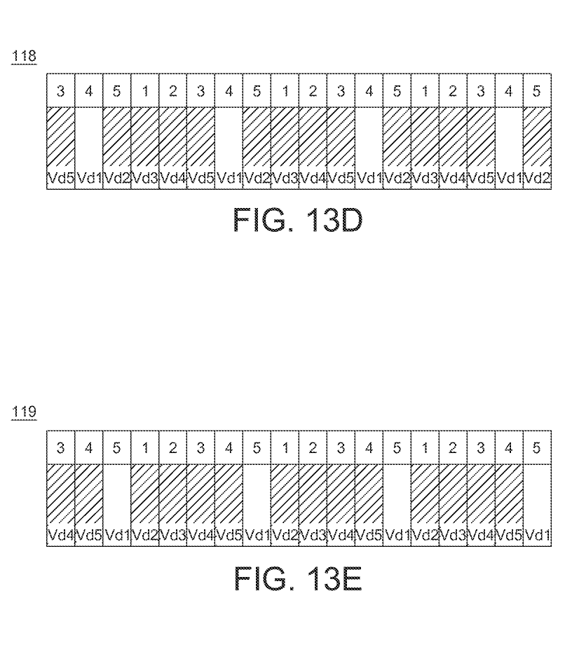

FIGS. 13A˜13E show schematic diagrams of the arrangements of the view information based on different disposition positions of the optical controlling elements according to an embodiment of the invention. Since the relationship by which the optical controlling elements correspond to the sub-pixels is not fixed, the following design is required to fix the relationship between the view pixel information and the optical controlling elements, wherein the x-axis denotes the view pixel information Vd(N). FIG. 13A shows the view pixel information arrangement 110 of the view pixel information Vd(N) when the optical controlling elements (such as the transparent areas of the grating) are disposed at the first position (view angle). FIG. 13B shows the arrangement 112 of the view pixel information Vd(N) when the optical controlling elements are disposed at the second position (view angle). FIG. 13C shows the arrangement 116 of the view pixel information Vd(N) when the optical controlling elements are disposed at the third position (view angle). FIG. 13D shows the arrangement 118 of the view pixel information Vd(N) when the optical controlling elements are disposed at the fourth position (view angle). FIG. 13E shows the arrangement 119 of the view pixel information Vd(N) when the optical controlling elements are disposed at the fifth position (view angle).

Referring to FIGS. 13A˜13E at the same time. The disposition position (the transparent area position) of each optical controlling element corresponds to the same view pixel information Vd(N). For example, the positions of the transparent areas in each row start from the view pixel information Vd1 and then are followed by the view pixel information Vd2, the view pixel information Vd3, the view pixel information Vd4 and the view pixel information Vd5 sequentially according to a periodic arrangement. In the present embodiment, 5 positions (view angles) are exemplified for description purpose, and accordingly there are 5 arrangements for the view pixel information Vd1˜Vd5 as illustrated in FIGS. 13A˜13E.

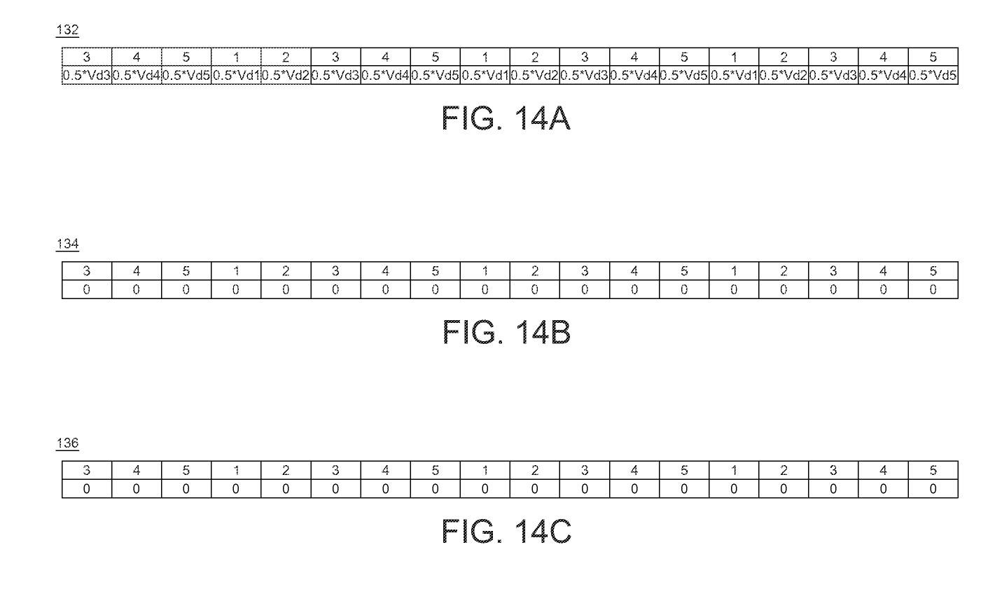

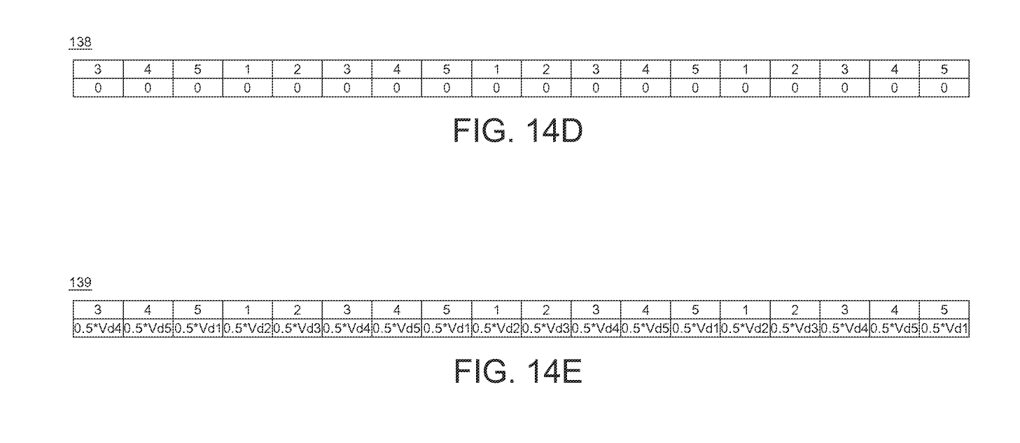

FIGS. 14A˜14E show schematic diagrams of the products of the view pixel information of the same row of sub-pixels and the corresponding weight information Vd(N) when the optical controlling elements are disposed at different positions (view angles). FIG. 14A shows a schematic diagram of the product 132 of the view pixel information Vd1 and the corresponding weight information when the transparent area is disposed at the first position (view angle). FIG. 14B shows a schematic diagram of the product 134 of the view pixel information Vd2 and the corresponding weight information when the transparent area is disposed at the second position (view angle). FIG. 14C shows a schematic diagram of the product 136 of the view pixel information Vd3 and the corresponding weight information when the transparent area is disposed at the third position (view angle). FIG. 14D shows a schematic diagram of the product 138 of the view pixel information Vd4 and the corresponding weight information when the transparent area is disposed at the fourth position (view angle). FIG. 14E shows a schematic diagram of the product 139 of the view pixel information Vd5 and the corresponding weight information when the transparent area is disposed at the fifth position (view angle).

As indicated in FIGS. 14A˜14E, in the same row of sub-pixels, the transparent areas are disposed between the first position (view angle) and the fifth position (view angle) (referring to the supplementary diagram). Therefore, the weight proportions assigned to the transparent areas disposed at the second position (view angle), the third position (view angle) and the fourth position (view angle) are all equal to 0. In other words, the sum of the product 132 of the view pixel information Vd1 and the corresponding weight information, the product 134 of the view pixel information Vd2 and the corresponding weight information, the product 136 of the view pixel information Vd3 and the corresponding weight information, the product 138 of the view pixel information Vd4 and the corresponding weight information, and the product 139 of the view pixel information Vd5 and the corresponding weight information is equal to the sum of 0.5 times of the product 132 of the view pixel information Vd1 and the corresponding weight information and 0.5 times of the product 139 of the view pixel information Vd5 and the corresponding weight information.

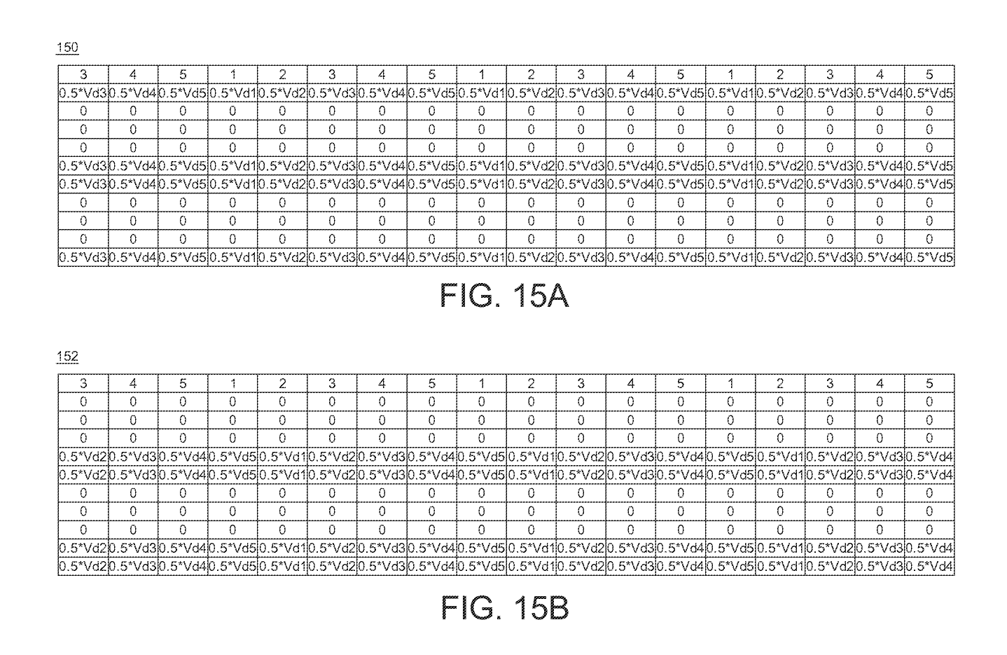

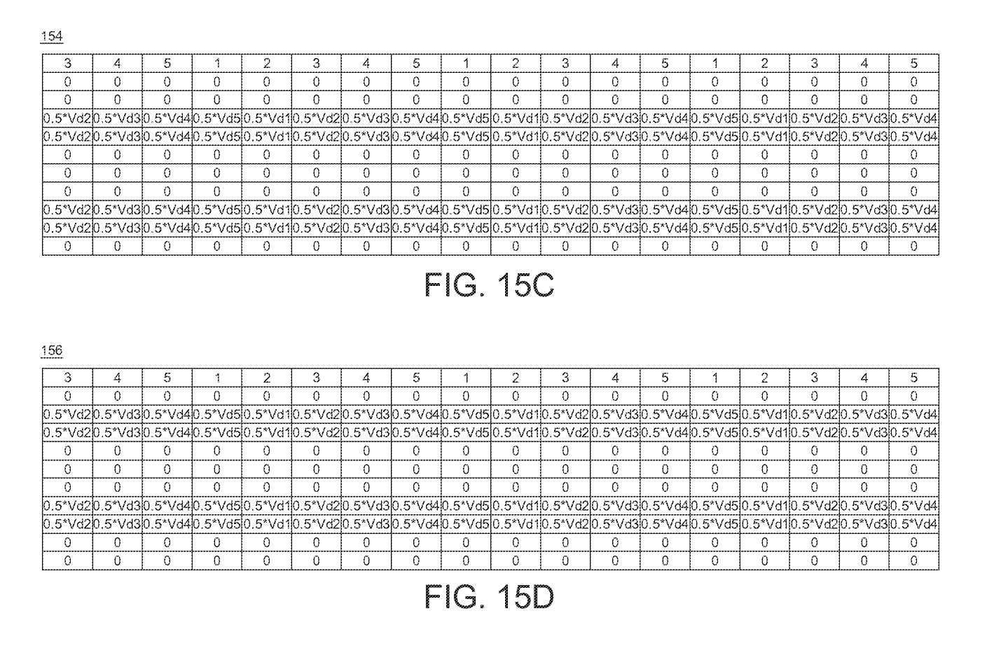

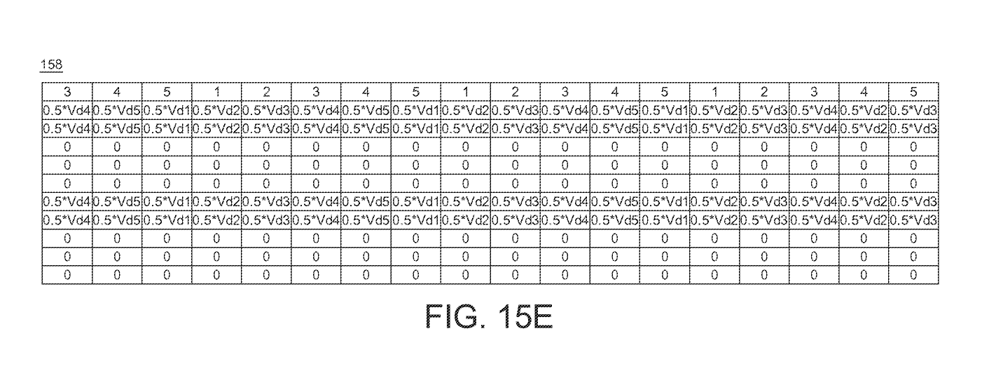

FIGS. 15A˜15E show schematic diagrams of an array of products of the view pixel information Vd(N) of a plurality of rows of sub-pixels and the corresponding weight information MXd(N) when the optical controlling elements are disposed at different positions (view angles). FIG. 15A shows a schematic diagram of a product array 150 of the view pixel information Vd1 and the corresponding weight information when the transparent area is disposed at the first position (view angle). FIG. 15B shows a schematic diagram of a product array 152 of the view pixel information Vd2 and the corresponding weight information when the transparent area is disposed at the second position (view angle). FIG. 15C shows a schematic diagram of a product array 154 of the view pixel information Vd3 and the corresponding weight information when the transparent area is disposed at the third position (view angle). FIG. 15D shows a schematic diagram of a product array 156 of the view pixel information Vd4 and the corresponding weight information when the transparent area is disposed at the fourth position (view angle). FIG. 15E shows a schematic diagram of a product array 158 of the view pixel information Vd5 and the corresponding weight information when the transparent area is disposed at the fifth position (view angle).

In FIGS. 15A˜15E, the disposition of transparent areas in a plurality of rows of sub-pixels and the weight information MXd(N) that the view pixel information Vd(N) need to correspond to are exemplified for description purpose. Since the arrangement of the transparent areas is based on the slope

$$\frac{a \times w}{b \times h} ,$$

each position (view angle) may correspond to the transparent area and involve the area proportion of the mapping sub-pixels to the unit mapping sub-pixels, and accordingly the weight information (the weight proportions) are generated. The sum of the product 150 of the view pixel information Vd1 and the corresponding weight information, the product 152 of the view pixel information Vd2 and the corresponding weight information, the product 154 of the view pixel information Vd3 and the corresponding weight information, the product 156 of the view pixel information Vd4 and the corresponding weight information, and the product 158 of the view pixel information Vd5 and the corresponding weight information is equal to the product of the view pixel information Vd of a plurality of rows of sub-pixels and the corresponding weight information MXd. Suppose the plurality of rows of sub-pixels are used to display a frame, then the sum of the products 150, 152, 154, 156 and 158 of the view pixel information Vd and the corresponding weight information MXd are the pixel information corresponding to the 5 positions (view angles) of the frame.

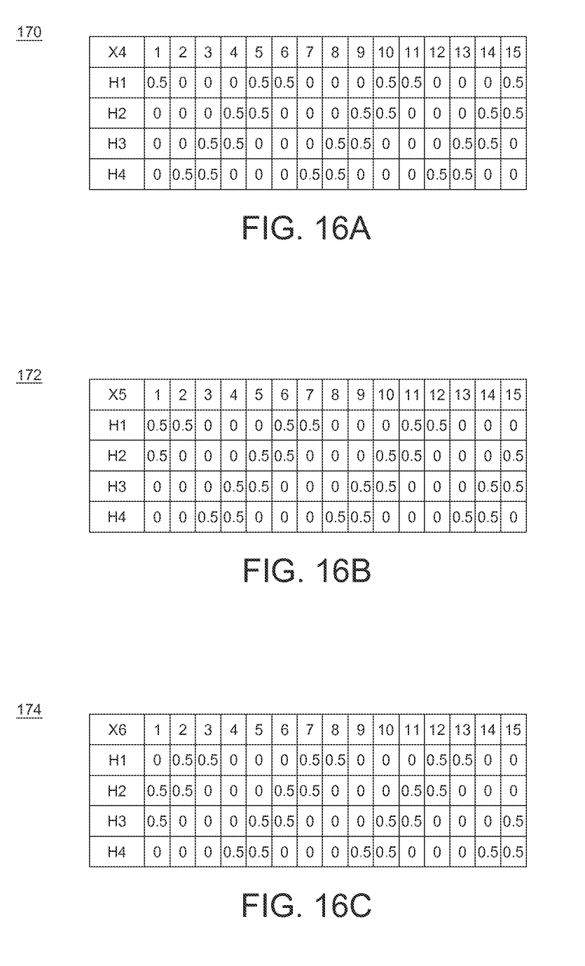

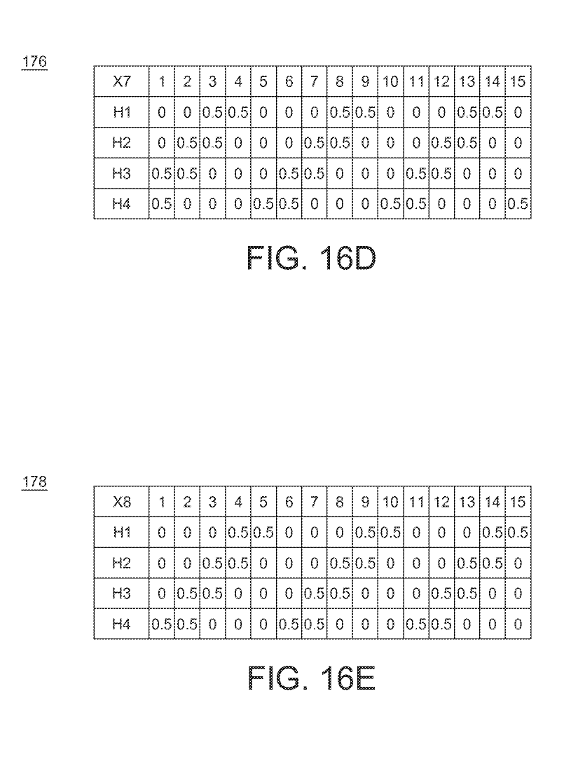

FIGS. 16A˜16E show schematic diagrams of arranging the separated weight information corresponding to each position (view angle) of FIGS. 15A˜15E according to corresponding coordinate positions to generate each computation table MX(N) of the view frame corresponding to each position (view angle). The number of computation tables corresponds to the number of view angles. Suppose there are N view angles, then N computation tables can be obtained, and the x-axis x4, x5, x6, x7 and x8 respectively denote the absolute positions of the sub-pixels in the horizontal direction. FIG. 16A shows a schematic diagram of a computation table 170 including the weight information corresponding to the first position (view angle). FIG. 16B shows a schematic diagram of a computation table 172 including the weight information corresponding to the second position (view angle). FIG. 16C shows a schematic diagram of a computation table 174 including the weight information corresponding to the third position (view angle). FIG. 16D shows a schematic diagram of a computation table 176 including the weight information corresponding to the fourth position (view angle). FIG. 16E shows a schematic diagram of a computation table 178 including the weight information corresponding to the fifth position (view angle). As indicated in FIGS. 16A˜16E, the weight information between each position (view angle) and its adjacent decreasing view angle are entirely shifted by an absolute position in a horizontal direction. For example, in comparison to the computation table 176 including the weight information corresponding to the fourth position (view angle) of FIG. 16D, the computation table 178 including the weight information corresponding to the fifth position (view angle) of FIG. 16E is shifted to the right by an absolute position in the horizontal direction.

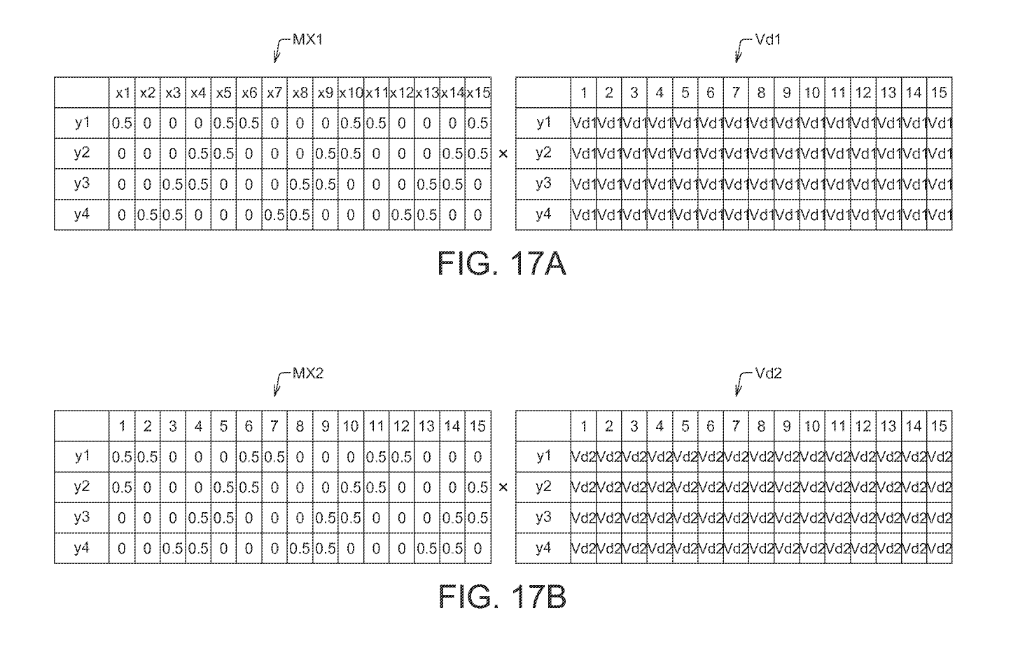

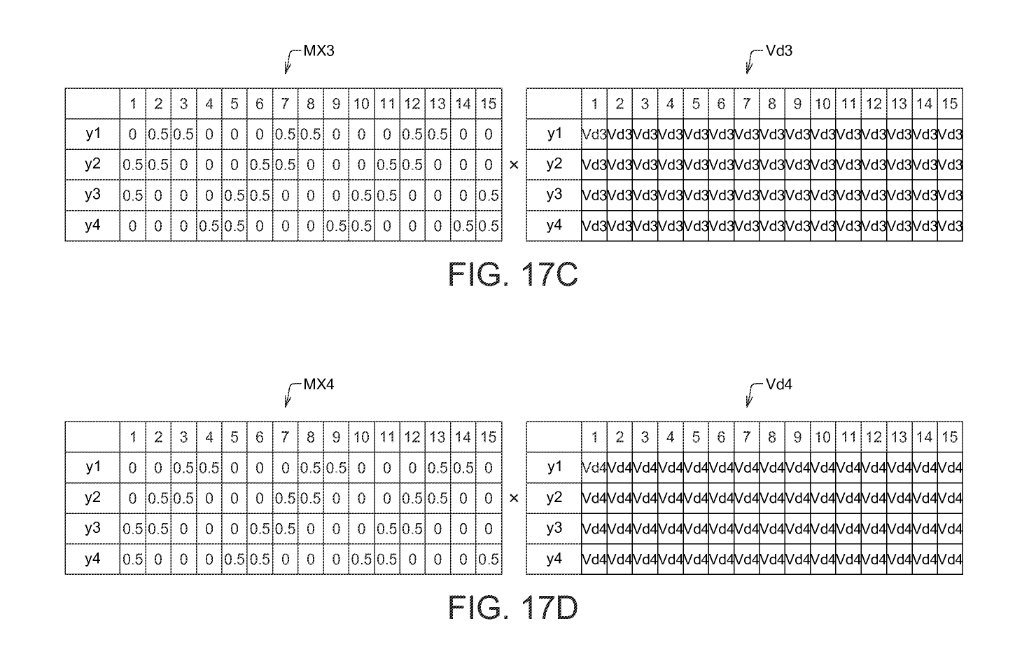

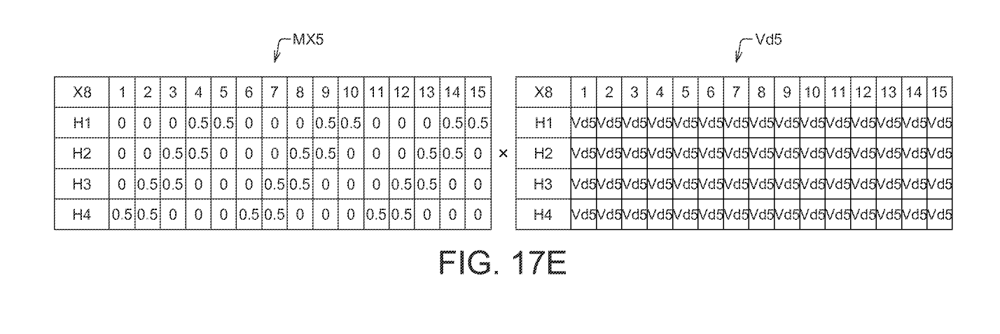

FIGS. 17A˜17E show schematic diagrams of a method of obtaining an adjusted view matrix table S′ by performing weight calculation (dot multiplication) on each computation table MX(N) and corresponding view frames V1˜V5. Suppose the number of view angles N of the 2D/3D switchable display device 10 is 5, then each of the 5 view frames V1˜V5 comprises the view pixel information Vd1˜Vd5, and the view pixel information Vd′_{(x,y)} applied to the view matrix table positions of the adjusted view matrix table S′ is expressed as:

$${Vd}_{( x , y )}^{′} = {\sum }_{n = 1}^{N} [ {MXd ( n )}_{( x , {y}^{′} )} \times {Vd ( n )}_{( x , y )} ] ( x = 1 \sim m ; y = 1 \sim {m}^{′} ) .$$

The present embodiment is different from the first embodiment in which matrix dot multiplication is performed on the computation table and the initial view matrix table S, where matrix dot multiplication is performed on the computation table and the view frames V1˜V5 in the present embodiment.

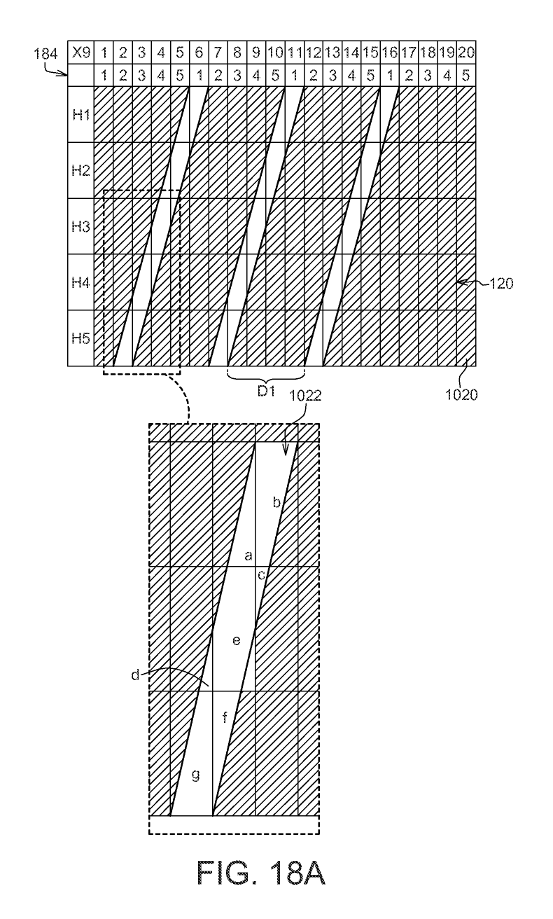

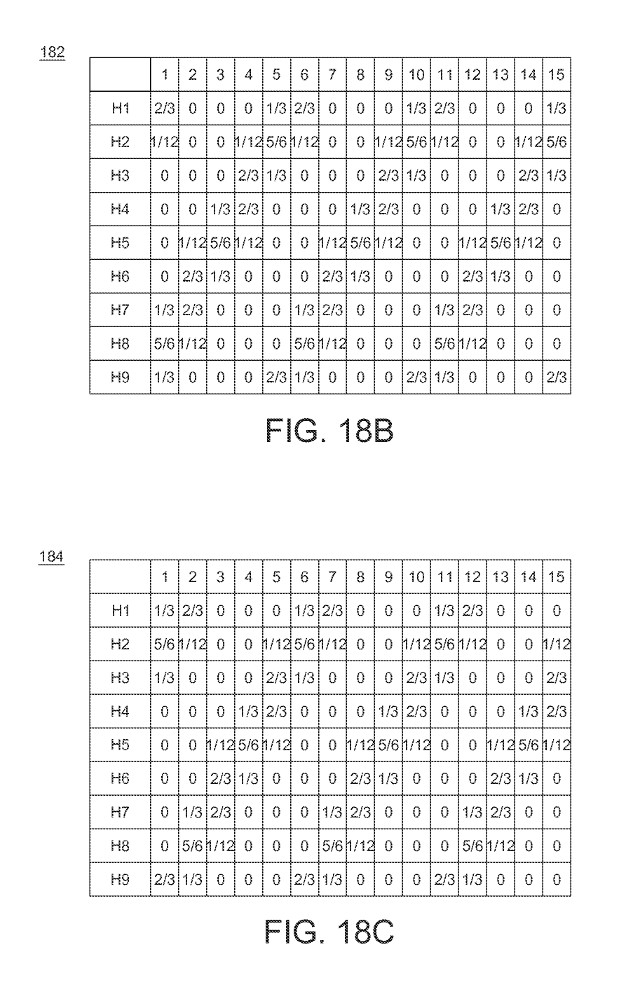

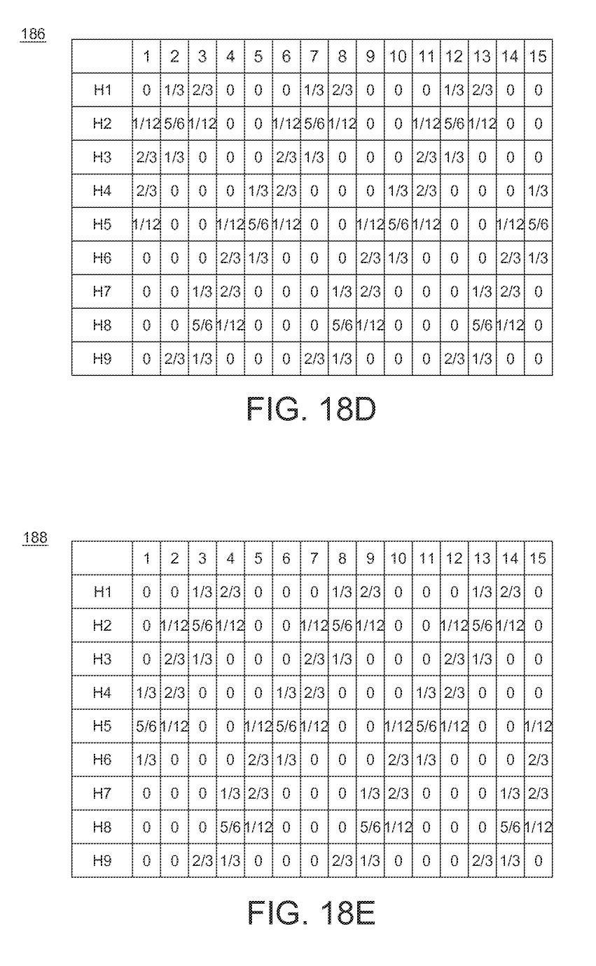

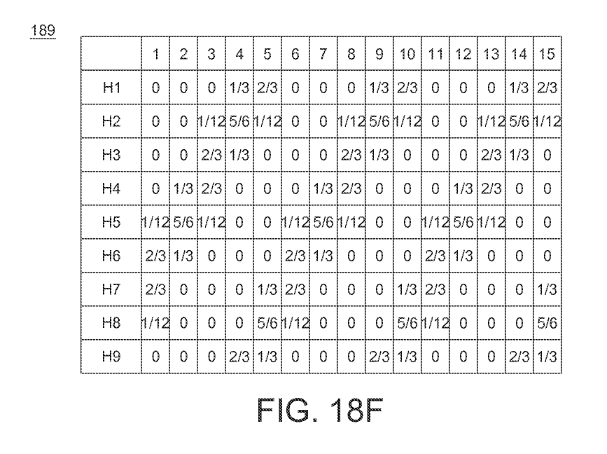

FIG. 18A shows a schematic diagram of the optical controlling elements 1022 arranged with the slope being 2w/3h according to another embodiment of the invention. In FIG. 18A, the number N of view angles of the display device 120 is 5, and the range of x=2˜4 and y=3˜5 is taken for example. The area proportions of the view pixel information Vd(N) of the sub-pixels 1020 exposed by the openings a˜g of the optical controlling elements 1022 respectively are summarized in Table 2 below.

TABLE 2

| Opening No. | Area Proportion |
|---|---|
| a | ⅓ |
| b | ⅔ |
| c | 1/12 |
| d | 1/12 |
| e | ⅚ |
| f | ⅓ |
| g | ⅔ |

The area proportions recorded in Table 2 can be used to generate computation tables MX1˜MX5. As indicated in FIGS. 18B˜18F, an adjusted view matrix table S′ is generated by performing weight calculation on each computation table MX(N) and corresponding view frames V1˜V5. FIG. 18A shows a schematic diagram of the optical controlling elements 1022. The disposition positions of the optical controlling elements 1022 correspond to the weight information recorded in the computation table corresponding to different view angles. FIG. 18B shows a schematic diagram of a computation table 182 of the weight information corresponding to the first position (view angle). FIG. 18C shows a schematic diagram of a computation table 184 of the weight information corresponding to the second position (view angle). FIG. 18D shows a schematic diagram of a computation table 186 of the weight information corresponding to the third position (view angle). FIG. 18E shows a schematic diagram of a computation table 188 of the weight information corresponding to the fourth position (view angle). FIG. 18F shows a schematic diagram of a computation table 189 of the weight information corresponding to the fifth position (view angle). The corresponding pixel information, that is, the adjusted view matrix table S′ can be obtained from the product of the weight information of FIGS. 18B˜18F and the corresponding view information.

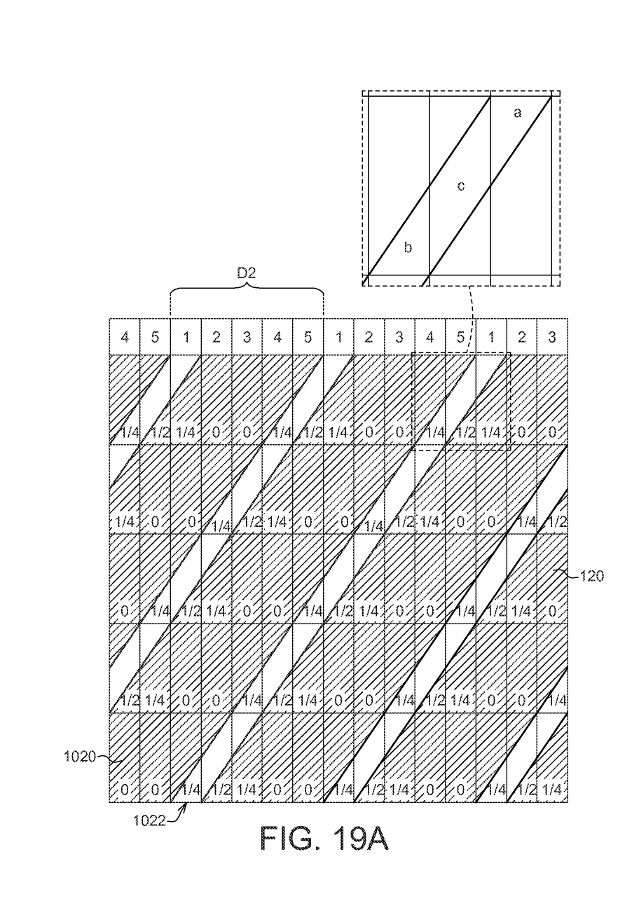

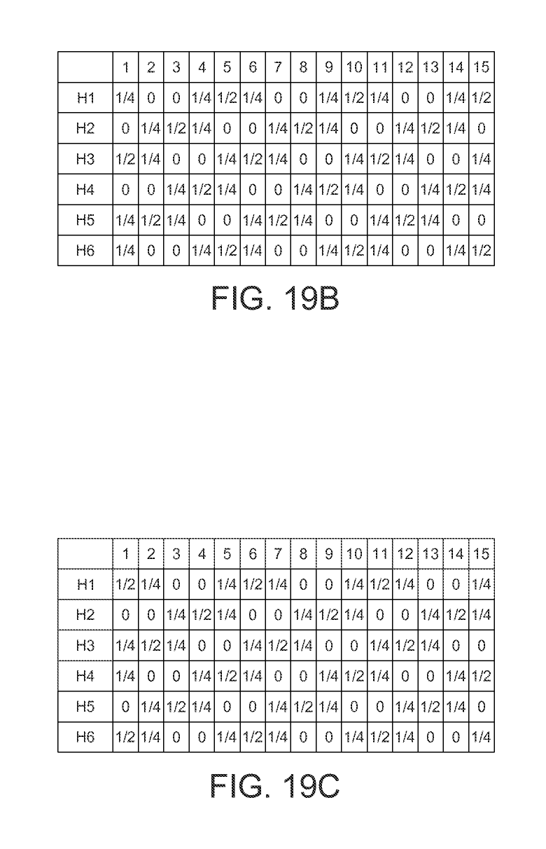

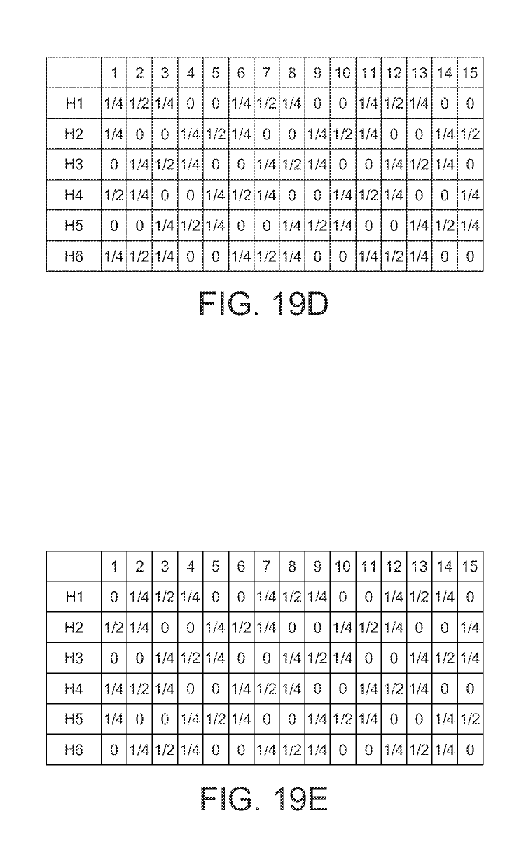

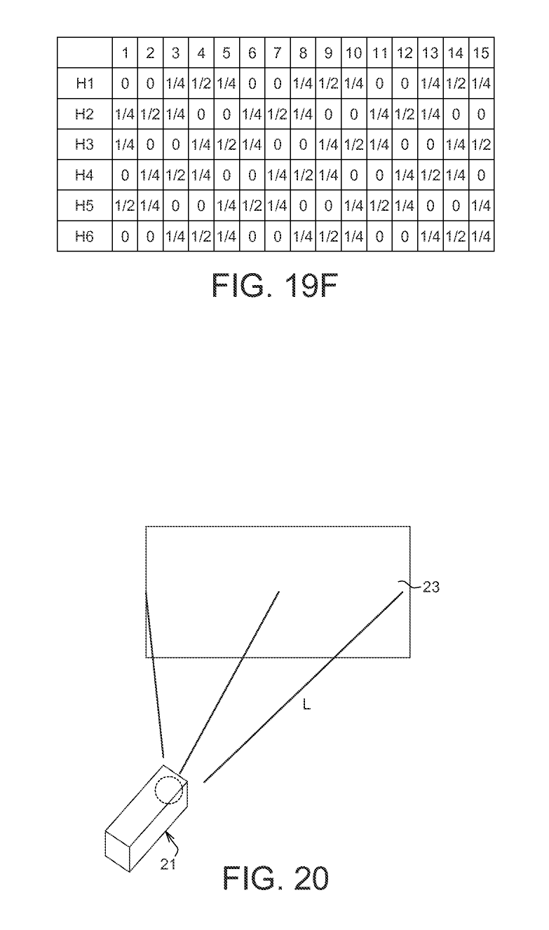

FIG. 19A shows a schematic diagram of the optical controlling elements 1022 arranged with the slope being 2w/h according to an alternate embodiment of the invention. In FIG. 19A, the number N of view angles of the display device 120 is 5, and the range of x=1˜3 and y=1 is taken for example. The area proportions of the view pixel information Vd(N) of the sub-pixels 1020 exposed by the openings a˜c of the optical controlling elements 1022 respectively are summarized in Table 3 below.

TABLE 3

| Opening No. | Area Proportion |
|---|---|
| a | ¼ |
| b | ¼ |
| c | ½ |

The area proportions recorded in Table 3 can be used to generate computation tables MX1˜MX5. As indicated in FIGS. 19B˜19F, an adjusted view matrix table S′ is generated by performing weight calculation (dot multiplication) on each computation table MX(N) and corresponding view frames V1˜V5.

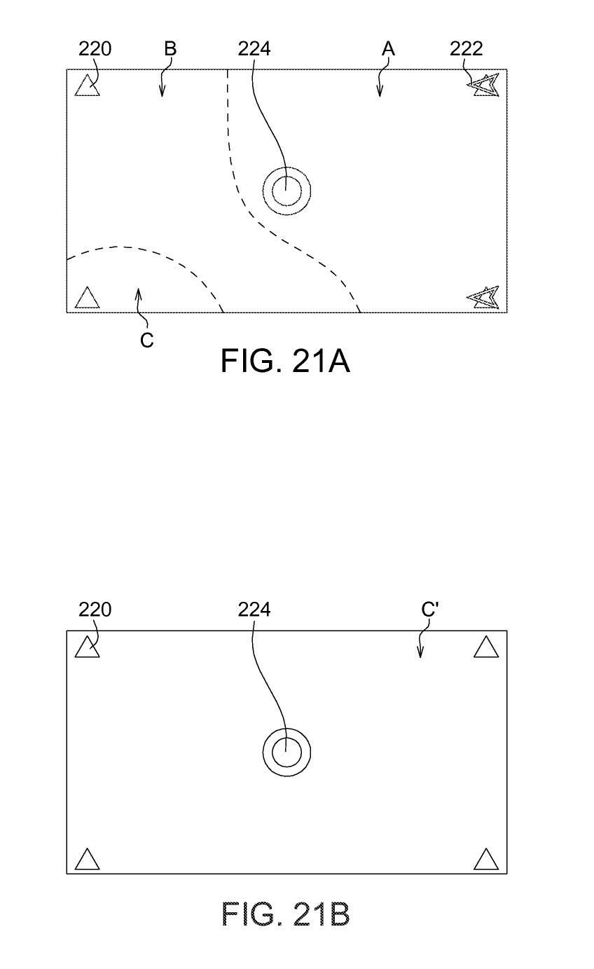

FIG. 20 shows a schematic diagram of an alignment detection method according to an embodiment of the invention. FIG. 21A shows a frame with misalignment. FIG. 21B shows a frame with precision alignment. During the manufacturing process of the 2D/3D switchable display device, alignment detection needs to be performed to assure the display module 120 and the optical control module 140 are assembled together with precision alignment. As indicated in FIG. 20, the 2D/3D switchable display device 23 of 5 view angles is taken for example. One view pixel information Vd of the initial view matrix table S can be set to have higher grey levels, and the remaining view pixel information Vd are set to have lower grey levels. For example, the view pixel information Vd1, Vd2, Vd4 and Vd5 of the initial view matrix table S may be set to have lower grey levels (such as a black frame whose grey level is 0), and the view pixel information Vd3 may be designed to have higher grey levels (such as a white frame whose grey level is 255).

Then, a light detector 21 (such as a CCD camera capable of separating the luminance) is aligned with the 2D/3D switchable display device 23 to detect the luminance L of the image to check whether the alignment is precise. If the alignment is precise, then all of the view pixel information Vd3 of the initial view matrix table S can transmit through the optical control module 140, and the light detector 21 will obtain the maximum luminance L. If the alignment is biased, then only a portion of the view pixel information Vd3 of the initial view matrix table S can transmit through the optical control module 140, and the light detector 21 will obtain lower luminance L or a specific pattern (a frame with partial white regions and partial black regions). In an embodiment, the grey level of the view pixel information Vd can be designed to be opposite to the above exemplification.

When alignment error occurs, the luminance of the whole frame is non-uniform. In the embodiment, as shown in FIG. 21A, the frame may be divided into, for example, three regions A, B, and C with different luminance, wherein region A has the lowest luminance and region C has the highest luminance. As indicated in FIG. 21A, when alignment error occurs, the driving module 160 can use the algorithm of the first, the second and the third embodiments to provide the adjusted view matrix table S′ or directly adjust the relative positions of the display module 120 and the optical control module 140, and then the detected luminance L is continuously quantified until the maximum luminance indicating correct alignment is obtained. The displayed frame is indicated in FIG. 21B. When the maximum luminance indicating correct alignment is obtained, the luminance of the whole frame is substantially uniform. In the embodiment, as shown in FIG. 21B, the frame has one region C′ with a uniform luminance, and the luminance of the region C′ as shown in FIG. 21B is equal to or larger than the luminance of the region C as shown in FIG. 21A. The viewing direction of FIG. 21A and FIG. 21B is normal to the screen of the display. There is some luminance disturbance coming form oblique viewing direction.

In an embodiment, the alignment pattern may comprise directional indicators at the four corners and a center indicator of the frame. The directional indicators are marks such as triangles, arrows or other marks capable of indicating direction. In FIG. 21A, when alignment error occurs, the directional indicators at the four corners will be inconsistent, and the center indicator 224 may overlap the directional indicators. For example, the directional indicator 220 at the left-hand side and the directional indicator 222 at the right-hand side will be inconsistent, and the center indicator 224 may overlap the directional indicator 222. The design of directional indicators can be used to assist adjusting the direction of alignment.

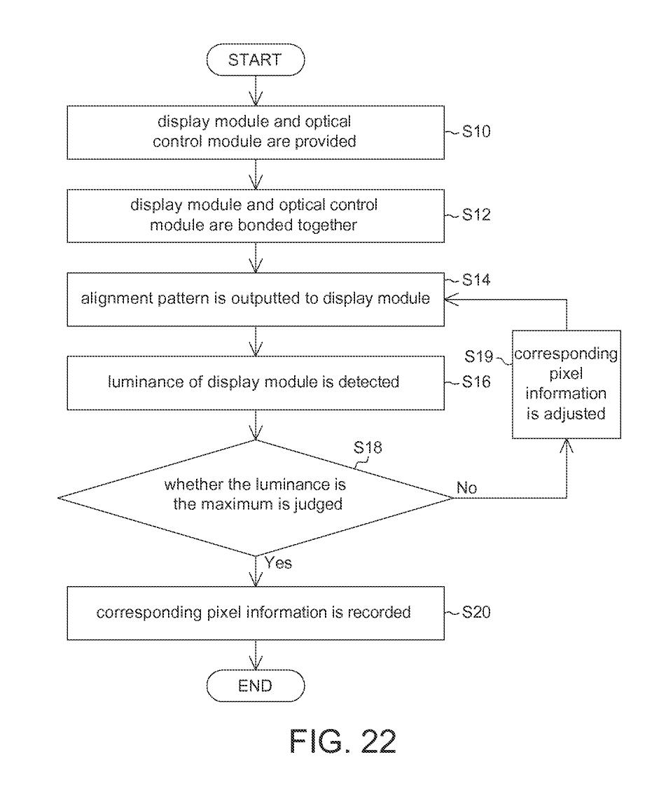

FIG. 22 shows a flowchart of an alignment detection method according to an embodiment of the invention. Referring to FIGS. 20 and 22 at the same time. In step S10, the display module 120 and the optical control module 140 are provided. In step S12, the display module 120 and the optical control module 140 are bonded together. Before the assembly step is performed, the display module 120 and the optical control module 140 can be directly bonded without alignment. In step S14, an alignment pattern (the initial view matrix table S) is outputted to the display module 120. In step S16, the luminance L of the display module is detected. In step S18, whether the luminance L is the maximum is judged. If yes, the method proceeds to step S20, the driving module 160 records the corresponding initial view matrix table S and its view pixel information Vd. If no, the method proceeds to S19, the driving module 160 uses the algorithm of the first and the second embodiment of the invention to adjust the corresponding initial view matrix table S and its view pixel information Vd, and step S18 is repeated until the adjusted view matrix information S′ with the maximum luminance L is obtained.

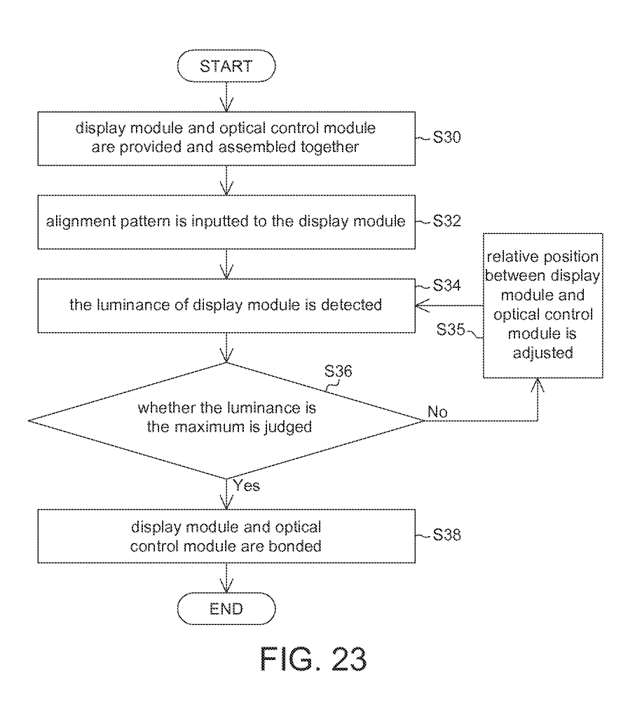

FIG. 23 shows a flowchart of an alignment detection method according to another embodiment of the invention. Referring to FIGS. 20 and 23 at the same time. In step S30, the display module 120 and the optical control module 140 are provided and assembled together. Currently, the display module 120 and the optical control module 140 are preliminarily assembled and the alignment does not need to be precise. In step S32, an alignment pattern (initial view matrix table S) is inputted to the display module 120. In step S34, the luminance L of the display module 120 is detected. In step S36, whether the luminance L is the maximum is judged. If yes, the method proceeds to step S38, the display module 120 and the optical control module 140 are bonded. If no, the method proceeds to S35, relative position between the display module 120 and the optical control module 140 is adjusted, and step S36 is repeated until the maximum luminance L is obtained.

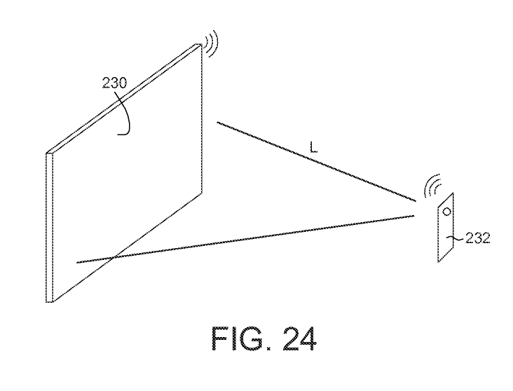

FIG. 24 shows a schematic diagram of an alignment detection method according to an embodiment of the invention. Let the display device 230 of 5 view angles as shown in FIG. 24 be taken for example. The optical control module (not illustrated) of the display device 230 can be suspended in front of the display module 120. For example, the optical control module 140 can be curtain type, page type or scroll type and can be combined with the display module 120, such that when the user views images at home, the user can decide whether the optical control module 140 covers the display module 120 according to the displayed frame being 2D or 3D.

However, when the relative position between the optical control module and the display module is adjusted, the display frame may be unable to display 3D image, and cross talk, jumping or moire effect may occur and affect the display quality. In the present embodiment, the user may use a portable light detector 232 (such as a remote controller with in-built light detection function) and make the driving module 160 perform the adjustment algorithm of the above embodiments when the display device 230 is booted.

In an embodiment, when the display device 230 enters a 3D adjustment mode, one of the view pixel information Vd can be set to have higher grey levels, and the remaining view pixel information Vd can be set to have lower grey levels. The light detector 232 is used to detect the luminance L of the displayed image frame, and the luminance L is sent to the driving module 160. Then, the driving module 160 can calculate and provide the adjusted view matrix table S′ according to the algorithm of the above embodiments of the invention and wirelessly transmits the result to inform the light detector 232. Then, the light detector 232 continues to detect the luminance L of the detected adjusted image frame. The present step is repeated until the luminance L detected by the light detector 232 reaches the maximum. Then, the adjusted view matrix table S′ with the maximum luminance L is recorded, and the detection and adjustment process is terminated.

According to a switchable display device and a manufacturing method thereof disclosed in the above embodiments of the invention, different algorithms are used to provide corresponding pixel information (the adjusted view matrix table S′). In an embodiment, through the compensation of the algorithm, the view pixel information of each pixel comprises the sum of more than one view information weighted by different proportions, hence improving the stereoscopic effect. In an embodiment of the invention, the view frame replaced in a reverse manner to generate corresponding pixel information, hence reducing the viewer's discomfort caused by the jumping of 3D frames. In addition, the algorithm of an embodiment of the invention further uses relative position information generated from the alignment error between the display module and the optical control module as compensation. Therefore, all the rotation alignment errors within a certain range can be adjusted through the algorithm of the present embodiment of the invention by providing corresponding pixel information, such that the viewer can view correct 3D image without having to assemble the optical control module and the display module by way of precision alignment. In an embodiment of the invention, based on the slopes of the optical controlling elements, corresponding pixel information are provided to provide better display effect and avoid cross talk and moire effect. In an embodiment of the invention, a simple alignment detection process is provided in the manufacturing process of display panel. Thus, the manufacturing cost can be largely reduced and product conformity rate can be largely increased.

While the invention has been described by way of example and in terms of the preferred embodiment (s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A manufacturing method of 2D/3D switchable display device, comprising:
providing a display module;
providing an optical control module;
assembling the display module and the optical control module;
electrically connecting the display module and the optical control module to a driving module; and
providing a pixel information to the display module by the driving module, comprising;
providing N initial view matrix tables formed from a plurality of view pixel information of N view frames, wherein N is the number of view angles and N is a positive integer greater or equal to 2;
providing N computation tables respectively corresponding to the initial view matrix tables, wherein each computation table has a plurality of weight information each respectively corresponding to each of the view pixel information; and
calculating the sum of the products of the view pixel information and the corresponding weight information, and it is the pixel information.

2. The manufacturing method of 2D/3D switchable display device according to claim 1, wherein the step of forming the initial view matrix tables from the view pixel information of the view frames comprises:
sequentially applying the view pixel information at the F^{th} position in the F^{th} view frame to the (F+zN)^{th} position in the first initial view matrix table to finish the first initial view matrix table;
sequentially applying the view pixel information at the F^{th} position in the (F+1)^{th} view frame to the (F+zN)^{th} position in the second initial view matrix table to finish the second initial view matrix table; and
sequentially applying the view pixel information at the F^{th} position until in the N^{th} view frame to the (F+zN)^{th} position in the N^{th} initial view matrix table to finish the N^{th} initial view matrix table;
wherein F is a positive integer ranging from 1 to N, and z is 0 or a positive integer.

3. The manufacturing method of 2D/3D switchable display device according to claim 2, wherein when N is an even number, the step of forming the initial view matrix tables from the view pixel information of the view frames comprises:
sequentially replacing the ((N/2)+2)^{th} view frame to the N^{th} view frame with the (N/2)^{th} view frame V(N/2) to the second view frame.

4. The manufacturing method of 2D/3D switchable display device according to claim 2, wherein when N is an odd number, the step of forming the initial view matrix tables from the view pixel information of the view frames comprises:
sequentially replacing the (((N+1)/2)+1)^{th} view frame to the N^{th} view frame with the ((N/1)/2)^{th} view frame V(N/2) to the second view frame.

5. The manufacturing method of 2D/3D switchable display device according to claim 1, wherein the sum of the weight information at the same position in the computation tables is less than or equal to 1.

6. The manufacturing method of 2D/3D switchable display device according to claim 5, wherein the computation tables have a plurality of rows whose weight information form a plurality of periodic functions, the adjacent periodic functions of each computation table have a first phase shift, the periodic functions in the same rows in the adjacent computation tables have a second phase shift, and the product of the second phase shift and N−1 is equal to the period of the periodic functions.

7. A 2D/3D switchable display device, comprising:
a display module;
an optical control module assembled with the display module; and
a driving module electrically connected to the display module and the optical control module to provide a pixel information to the display module, wherein, the pixel information is related to N initial view matrix tables and N computation tables, the initial view matrix tables are formed from a plurality of view pixel information of N view frames, N is the number of view angles and is a positive integer greater or equal to 2, the computation tables respectively correspond to the initial view matrix tables, each computation table has a plurality of weight information respectively corresponding to the view pixel information, and the pixel information is the sum of the products of the view pixel information and the corresponding weight information.

8. The 2D/3D switchable display device according to claim 7, wherein the initial view matrix tables are formed from the view pixel information of the view frames, a first initial view matrix table of the initial view matrix tables comprises the view pixel information sequentially applied to the (F+zN)^{th} position in the first initial view matrix table from the F^{th} position in the F^{th} view frame, a second initial view matrix table of the initial view matrix tables comprises the view pixel information sequentially applied to the (F+zN)^{th} position in the second initial view matrix table from the F^{th} position in the (F+1)^{th} view frame, and an N^{th} initial view matrix table of the initial view matrix tables comprises the view pixel information sequentially applied to the (F+zN)^{th} position in the N^{th} initial view matrix table from the F^{th} position in the N^{th} view frame, wherein F a positive integer ranging from 1 to N, and z is 0 or a positive integer.

9. The display device according to claim 8, wherein when N is an even number, the initial view matrix tables comprise the ((N/2)+2)^{th} view frame to the N^{th} view frame sequentially replaced by the (N/2)^{th} view frame V(N/2) to the second view frame.

10. The display device according to claim 8, wherein when N is an odd number, the initial view matrix tables comprise the (((N+1)/2)+1)^{th} view frame to the N^{th} view frame sequentially replaced by the ((N/1)/2)^{th} view frame V(N/2) to the second view frame.

11. The display device according to claim 7, wherein the sum of the weight information in the same position in the computation tables is less than or equal to 1.

12. The display device according to claim 11, wherein the computation tables have a plurality of rows whose weight information form a plurality of periodic functions, the adjacent periodic functions of each computation table have a first phase shift, the periodic functions of the same rows in the adjacent computation tables have a second phase shift, and the product of the second phase difference and N−1 is equal to the period of the periodic functions.

13. The 2D/3D switchable display device according to claim 7, wherein the driving module comprises:
a storage device for storing the initial view matrix tables, the computation tables and the pixel information;
a signal generation device for generating the computation tables;
an adjustment device capable of adjusting the weight information of the computation tables; and
a processor for calculating the sum of the products of the view pixel information and the weight information.

14. The 2D/3D switchable display device according to claim 7, wherein the display module comprises a first alignment pattern, the optical control module comprises a second alignment pattern, the first alignment pattern and the second alignment pattern are disposed oppositely and an angle is greater than 0.1° and smaller than 15° therebetween.

15. The manufacturing method of 2D/3D switchable display device according to claim 1, wherein the display module has a plurality of sub-pixels, the optical control module has a plurality of optical controlling elements, the optical controlling elements has a slope with respect to the sub-pixels and covers at least two sub-pixels, and the step of providing the computation tables comprises:
in one of the view angles, covering the area of the sub-pixels by the optical controlling element for forming a plurality of the weight information, and calculating the product of the view pixel information at N adjacent and consecutive positions of the sub-pixels and the corresponding weight information;
calculating of the product of the view pixel information and the weight information in other view angles; and
sifting the weight information of the same view pixel information for the computation tables.

16. The manufacturing method of 2D/3D switchable display device according to claim 15, wherein the initial view matrix tables are the view frames.

17. The manufacturing method of 2D/3D switchable display device according to claim 1, further comprising:
detecting the assembly error between the display module and the optical control module for adjusting the pixel information, comprising:
setting one of the view frames as a white frame or a black frame, wherein the remaining view frames are relative black frames or white frames;
detecting the luminance of the display module display by a light detector; and
adjusting the pixel information until the luminance of the display module is maximum when one of the view frames is a white frame; and
adjusting the pixel information until the luminance of the display module display is minimum when one of the view frames is a black frame.

18. The manufacturing method of 2D/3D switchable display device according to claim 1, further comprising:
detecting the assembly error between the display module and the optical control module for adjusting the pixel information, comprising:
providing at least two view alignment patterns to the display module by the driving module, wherein the view alignment patterns comprise at least one 2D alignment pattern and at least one 3D alignment pattern; and
adjusting the pixel information until one of the alignment patterns is substantially covered by the optical control module.

19. The manufacturing method of 2D/3D switchable display device according to claim 18, wherein there is a relative shift or relative width difference between the 3D alignment patterns.

20. The manufacturing method of 2D/3D switchable display device according to claim 1, wherein the sum of the products of the view pixel information and the weight information is limited to the same position in each of the initial view matrix tables and each of the computation tables.
